(19) United States
(12) Patent Application Publication
(10) Pub. No.: US 2026/0194857 A1
(43) Pub. Date: Jul. 9, 2026

(54) DRIVING FORCE RECEIVING MEMBER, ROTATING ASSEMBLY AND PROCESS CARTRIDGE

(71) Applicant: E-Z INK TECHNOLOGY CO., LTD, Zhuhai (CN)

(72) Inventors: Shengkui ZHAO, Zhuhai (CN); Dongming LIN, Zhuhai (CN); Peng WANG, Zhuhai (CN); Hangyu PENG, Zhuhai (CN)

(73) Assignee: E-Z INK TECHNOLOGY CO., LTD, Zhuhai (CN)

(21) Appl. No.: 19/555,926

(22) Filed: Mar. 4, 2026

Related U.S. Application Data
(63) Continuation of application No. 18/661,578, filed on May 11, 2024, now Pat. No. 12,591,200.
Application No. 18/661,578 is a continuation-in-part of application No. PCT/CN2022/131575, filed on Nov. 12, 2022.

(30) Foreign Application Priority Data
Nov. 12, 2021 (CN) 202122784760.4
Mar. 18, 2022 (CN) 202220611605.4
Sep. 22, 2022 (CN) 202222519967.3
Oct. 1, 2022 (CN) 202222636008.X
Oct. 24, 2022 (CN) 202222810125.3
Nov. 1, 2022 (CN) 202222907750.X
Nov. 3, 2022 (CN) 202222933490.3

(51) Int. Cl. G03G 21/18

(52) U.S. Cl. CPC G03G 21/1864

(57) ABSTRACT

Provided are driving force receiving member, a rotating assembly with the driving force receiving member, and a process cartridge. The driving force receiving member is used for receiving a driving force from an image forming apparatus, the image forming apparatus has a driving portion and a braking portion which rotate in the same direction, the braking portion rotates with the driving portion, the braking portion moves relative to the driving portion, and the braking portion is located on a downstream side of the driving portion in a direction of rotation; when the driving portion rotates, the driving force receiving member is driven by the driving portion or the braking portion, and when the driving portion stops applying the driving force to the driving force receiving member, the driving force receiving member is not braked by the braking portion; and abrasion of the driving force receiving member can be relieved.

### CROSS REFERENCE TO THE RELATED APPLICATIONS

This application is the continuation application of U.S. application Ser. No. 18/661,578 filed on May 11, 2024, which is the continuation-in-part application of International Application No. PCT/CN2022/131575, filed on Nov. 12, 2022, which is based upon and claims priority to Chinese Patent Applications No. 202122784760.4, filed on Nov. 12, 2021; 202220611605.4, filed on Mar. 18, 2022; 202222519967.3, filed on Sep. 22, 2022; 202222636008.X, filed on Oct. 1, 2022; 202222810125.3, filed on Oct. 24, 2022; 202222907750.X, filed on Nov. 1, 2022; 202222933490.3, filed on Nov. 3, 2022; the entire contents of which are incorporated herein by reference.

### TECHNICAL FIELD

The present invention relates to the field of electrophotographic image forming, in particular to a process cartridge detachably mounted in an electrophotographic image forming apparatus, and a rotating assembly and a driving force receiving member which are rotationally mounted in the process cartridge.

### BACKGROUND

A Chinese patent application CN113574469A has disclosed a force output member (driving force transmission unit on a main assembly side) 203 in an image forming apparatus M. As shown in FIG. 43 in this patent application, the force output member 203 has an axis of rotation M1, and includes a driving force output member (drum drive coupling) 180 for outputting a driving force and a braking force output member (including a first braking engagement member 204 and a second braking engagement member 208) for outputting a braking force, and when the force output member 203 outputs the driving force to a driving force receiving member X4 as described below, the braking force output member is driven by the driving force output member 180 to rotate with the driving force output member.

As shown in FIG. 45 in this patent application, a driving force output surface (drive transmission surface) 180d and a flange portion 180a are arranged at two ends of the driving force output member 180 respectively along the axis of rotation M1; and as shown in FIG. 43, the first braking engagement member 204 has a flange portion 204a and a coupling engaging portion 204b projecting from the flange portion 204a, the coupling engaging portion 204b is arranged to project towards the axis of rotation M1 of the force output member like a claw, the second braking engagement member 208 also has a flange portion 208a and a coupling engaging portion 208b projecting from the flange portion 208a, the coupling engaging portion 208b is also arranged to project towards the axis of rotation M1 of the force output member like a claw, in a radial direction perpendicular to the axis of rotation M1, the first braking engagement member 204 is located on an outer side of the second braking engagement member 208, the coupling engaging portion 204b is located on an outer side of the coupling engaging portion 208b, and the first braking engagement member 204 and the second braking engagement member 208 can rotate around the axis of rotation M1 at the same time.

FIG. 1A is a stereogram of an existing process cartridge; and FIG. 1B is a stereogram of a rotating member with an existing driving force receiving member.

The Chinese patent application CN113574469A has further disclosed a rotating member 21 with the existing driving force receiving member X4 as shown in FIG. 1B. The rotating member 21 and the driving force receiving member X4 are suitable for the existing process cartridge C as shown in FIG. 1A. The process cartridge C includes a first unit 100 and a second unit 200 which engage with each other, and the driving force receiving member X4 for receiving the driving force from the image forming apparatus, the first unit 100 includes a first unit casing 1 and a first rotating member 11 rotationally mounted in the first unit casing 1, the second unit 200 includes a second unit casing 2 and a second rotating member 21 rotationally mounted in the second unit casing 2, and the driving force receiving member X4 is arranged at one longitudinal tail end of the process cartridge C, and drives at least one of the first rotating member 11 and the second rotating member 21 to rotate.

Taking an example that the second rotating member 21 rotates around an axis of rotation L21, as shown in FIG. 1B, the driving force receiving member X4 engages with the second rotating member 21, and includes a base tray X42, a substrate X43 and an engaging portion X44, the base tray X42, the substrate X43 and the engaging portion X44 are sequentially arranged along the axis of rotation L21, the engaging portion X44 includes a central pillar X45 and a driving force receiving portion X46 extending outwards in a radial direction of the central pillar X45, the driving force receiving portion X46 has a guide surface X463 helically extending in a circumferential direction of the axis of rotation L21, and a driving surface X464 and a braking surface X465 which are arranged adjacent to the guide surface, and the guide surface X463 is located above the braking surface X465 along the axis of rotation L21.

In the mounting process of the process cartridge C, the guide surface X463 at least abuts against the coupling engaging portion 208b in the second braking engagement member 208, to guide the driving force receiving portion X46 to enter a position between a driving force output surface 180d and the coupling engaging portion 208b/204b; and when the process cartridge C operates, the driving force output surface 180d outputs the driving force to the driving surface X464, to drive the rotating member 21 to rotate, and the braking force output member is used for applying the braking force to the braking surface X465 on a downstream side of a direction of rotation of the receiving portion X46.

### SUMMARY

The present invention provides a process cartridge, so as to further develop the above technology and relieve abrasion of a driving force receiving member.

The driving force receiving member is used for receiving a driving force from an image forming apparatus, wherein the image forming apparatus has a driving portion and a braking portion, and the driving portion and the braking portion rotate in the same direction, the braking portion can rotate with the driving portion, the braking portion can move relative to the driving portion, and the braking portion is located on a downstream side of the driving portion in a direction of rotation; and when the driving portion rotates, the driving force receiving member is driven by the driving portion or the braking portion, and the driving force receiving member is not braked by the braking portion.

In some implementations, the driving force receiving member includes a connecting portion and an engaging portion, wherein the connecting portion is used for being connected with an external component of the driving force receiving member, the engaging portion includes a guide surface, a first surface and a second surface, wherein the first surface and the second surface are adjacent to the guide surface, the guide surface guides the braking portion to move relative to the driving portion, the first surface is used for abutting against the driving portion or the braking portion to receive the driving force, and the second surface is spaced from the braking portion.

In some implementations, when the driving force receiving member is driven, the braking portion is pressed by the driving force receiving member to retract.

In some implementations, the driving force receiving member can be mounted to the image forming apparatus with the process cartridge, the driving force receiving member has driving force receiving portions, each driving force receiving portion has a surface for receiving the driving force, and when the process cartridge is mounted at a preset position of the image forming apparatus, the surface reaches a downstream side of the braking portion in the direction of rotation.

In some implementations, when the driving force receiving member is driven, the braking portion is disabled, and the image forming apparatus transmits the driving force to the driving force receiving member through the driving portion or the braking portion.

The present invention further provides a driving force receiving member for receiving a driving force from an image forming apparatus. The image forming apparatus has a driving portion and a braking portion, wherein the driving portion and the braking portion rotate in the same direction, the braking portion is configured to rotate with the driving portion, the braking portion is configured to move relative to the driving portion, and the braking portion is located on a downstream side of the driving portion in a direction of rotation; and the driving force receiving member is driven by the driving portion or the braking portion, the driving force receiving member is spaced from the braking portion in the direction of rotation, or the braking portion retracts relative to the driving portion, or a part of the driving force receiving member is located on a downstream side of the braking portion in the direction of rotation.

The present invention further provides a process cartridge, including a casing, a rotating member rotationally supported by the casing, and the above driving force receiving member. The driving force receiving member directly or indirectly drives the rotating member.

### BRIEF DESCRIPTION OF THE DRAWINGS

FIG. 1A is a stereogram of an existing process cartridge.

FIG. 1B is a stereogram of a rotating member with an existing driving force receiving member.

FIG. 2A is a stereogram of an existing force output member.

FIG. 2B is a local stereogram of an existing force output member.

FIG. 2C is a local stereogram after hiding a braking force output member in an existing force output member.

FIG. 2D is a top view as viewed along an axis of rotation of an existing force output member.

FIG. 3A and FIG. 3B are stereograms of a process cartridge involved in the present invention.

FIG. 4A is a stereogram of a photosensitive drum of a driving force receiving member involved in Embodiment 1 of the present invention.

FIG. 4B is a stereogram of a first driving force receiving member involved in Embodiment 1 of the present invention.

FIG. 4C is a side view as viewed along an axis of rotation of a first driving force receiving member involved in Embodiment 1 of the present invention.

FIG. 5A is a stereogram of a driving force receiving member involved in Embodiment 2 of the present invention.

FIG. 5B is a side view as viewed along an axis of rotation of a driving force receiving member involved in Embodiment 2 of the present invention.

FIG. 6A is a stereogram of a driving force receiving member involved in Embodiment 3 of the present invention.

FIG. 6B is a side view as viewed along an axis of rotation of a driving force receiving member involved in Embodiment 3 of the present invention.

FIG. 7 is a stereogram of a driving force receiving member involved in Embodiment 4 of the present invention.

FIG. 8A and FIG. 8B are schematic state diagrams before and after engagement of a driving force receiving member with a driving force output member and a braking force output member in an image forming apparatus involved in Embodiment 4 of the present invention.

FIG. 9 is a sectional view after sectioning along a plane perpendicular to an axis of rotation of a driving force receiving member after engagement of the driving force receiving member with a driving force output member and a braking force output member in an image forming apparatus involved in Embodiment 4 of the present invention.

FIG. 10A and FIG. 10B are schematic state diagrams before and after engagement of a driving force receiving member with a driving force output member and a braking force output member in an image forming apparatus involved in Embodiment 5 of the present invention.

FIG. 11A is a stereogram of a driving force receiving member involved in Embodiment 6 of the present invention.

FIG. 11B is a side view of a driving force receiving member as viewed in a direction perpendicular to an axis of rotation of the driving force receiving member involved in Embodiment 6 of the present invention.

FIG. 11C is a side view of a driving force receiving member as viewed along an axis of rotation of the driving force receiving member involved in Embodiment 6 of the present invention.

FIG. 12A is a stereogram of a variant structure of a driving force receiving member involved in Embodiment 6 of the present invention.

FIG. 12B is a side view of a driving force receiving member as viewed along an axis of rotation of the driving force receiving member shown in FIG. 12A.

FIG. 13A is a stereogram of another variant structure of a driving force receiving member involved in Embodiment 6 of the present invention.

FIG. 13B is a side view of a driving force receiving member as viewed in a direction perpendicular to an axis of rotation of the driving force receiving member shown in FIG. 13A.

FIG. 14A is a stereogram of a driving force receiving member involved in Embodiment 7 of the present invention.

FIG. 14B is a side view of a driving force receiving member as viewed in a direction perpendicular to an axis of rotation of the driving force receiving member involved in Embodiment 7 of the present invention.

FIG. 15A is a stereogram of a variant structure of a driving force receiving member involved in Embodiment 7 of the present invention.

FIG. 15B is a side view of a driving force receiving portion as viewed in a direction perpendicular to an axis of rotation of the driving force receiving member involved in Embodiment 7 of the present invention.

FIG. 16A is a stereogram of a driving force receiving member involved in Embodiment 8 of the present invention.

FIG. 16B is a sectional view after sectioning along a plane perpendicular to an axis of rotation in FIG. 16A and passing through a braking surface.

FIG. 17 is a stereogram of a driving force receiving member involved in Embodiment 9 of the present invention.

FIG. 18 is a stereogram of a variant structure of a driving force receiving member involved in Embodiment 9 of the present invention.

FIG. 19 is a stereogram of a driving force receiving member involved in Embodiment 10 of the present invention.

FIG. 20A is a stereogram showing that a driving force receiving member starts to engage with a force output member involved in Embodiment 10 of the present invention.

FIG. 20B is a stereogram after engagement of a driving force receiving member with a force output member involved in Embodiment 10 of the present invention.

FIG. 20C is a side view as viewed in a direction perpendicular to an axis of rotation of a driving force receiving member after engagement of the driving force receiving member with a force output member involved in Embodiment 10 of the present invention.

FIG. 21A is a stereogram of a driving force receiving member involved in Embodiment 11 of the present invention.

FIG. 21B is a schematic decomposition diagram of a driving force receiving member involved in Embodiment 11 of the present invention.

FIG. 22 is a stereogram of a driving force receiving member involved in Embodiment 12 of the present invention.

FIG. 23A is a stereogram showing that a driving force receiving member starts to engage with a force output member involved in Embodiment 12 of the present invention.

FIG. 23B is a stereogram after engagement of a driving force receiving member with a force output member involved in Embodiment 12 of the present invention.

FIG. 23C is a side view as viewed in a direction perpendicular to an axis of rotation of a driving force receiving member after engagement of the driving force receiving member with a force output member involved in Embodiment 12 of the present invention.

FIG. 24 is a schematic decomposition diagram of a driving force receiving member involved in Embodiment 13 of the present invention.

FIG. 25A is a stereogram showing that a driving force receiving member starts to engage with a force output member involved in Embodiment 13 of the present invention.

FIG. 25B is a stereogram after engagement of a driving force receiving member with a force output member involved in Embodiment 13 of the present invention.

FIG. 25C is a side view as viewed in a direction perpendicular to an axis of rotation of a driving force receiving member after engagement of the driving force receiving member with a force output member involved in Embodiment 13 of the present invention.

FIG. 26 is a schematic decomposition diagram of a driving force receiving member involved in Embodiment 14 of the present invention.

FIG. 27A is a state diagram of a driving force receiving member in a process cartridge before engagement of the driving force receiving member with a force output member involved in Embodiment 14 of the present invention.

FIG. 27B is a stereogram before engagement of a driving force receiving member with a force output member involved in Embodiment 14 of the present invention.

FIG. 28 is a state diagram of a driving force receiving member in a process cartridge after engagement of the driving force receiving member with a force output member involved in Embodiment 14 of the present invention.

FIG. 29 is a stereogram of a driving force receiving member involved in Embodiment 15 of the present invention.

FIG. 30A is a stereogram as viewed in a direction intersecting with an axis of rotation of a driving force receiving member before engagement of the driving force receiving member with a force output member in a first state involved in Embodiment 15 of the present invention.

FIG. 30B is a stereogram as viewed in another direction intersecting with an axis of rotation of a driving force receiving member after engagement of the driving force receiving member with a force output member in a first state involved in Embodiment 15 of the present invention.

FIG. 31A is a stereogram after engagement of a driving force receiving member with a force output member in a first state involved in Embodiment 15 of the present invention.

FIG. 31B is a stereogram as viewed in a direction perpendicular to an axis of rotation of a driving force receiving member after engagement of the driving force receiving member with a force output member in a first state involved in Embodiment 15 of the present invention.

FIG. 32 is a stereogram as viewed in a direction perpendicular to an axis of rotation of a driving force receiving member when the driving force receiving member starts to engage with a force output member in a second state involved in Embodiment 15 of the present invention.

FIG. 33 is a stereogram of a driving force receiving member involved in Embodiment 16 of the present invention.

FIG. 34A is a stereogram after engagement of a driving force receiving member with a driving force output member involved in Embodiment 16 of the present invention.

FIG. 34B is a side view as viewed in a direction perpendicular to an axis of rotation of a driving force receiving member after engagement of the driving force receiving member with a driving force output member involved in Embodiment 16 of the present invention.

FIG. 35 is a stereogram of a driving force receiving member involved in Embodiment 17 of the present invention.

FIG. 36 is a schematic state diagram after separating an engaging portion of a driving force receiving member from a substrate involved in Embodiment 17 of the present invention.

FIG. 37 is a side view as viewed in a direction perpendicular to an axis of rotation of a driving force receiving member involved in Embodiment 17 of the present invention.

FIG. 38 is a side view as viewed in a direction perpendicular to an axis of rotation of a driving force receiving member after engagement of the driving force receiving member with a force output member involved in Embodiment 17 of the present invention.

FIG. 39 is a stereogram of a driving force receiving member involved in Embodiment 18 of the present invention.

FIG. 40 is a stereogram of a driving force receiving member involved in Embodiment 19 of the present invention.

FIG. 41 is a stereogram showing engagement of a driving force receiving member and a force output member involved in Embodiment 19 of the present invention.

FIG. 42 is a schematic decomposition diagram of a driving force receiving member involved in Embodiment 20 of the present invention.

FIG. 43A is a stereogram of a driving force receiving member involved in Embodiment 20 of the present invention.

FIG. 43B of a side view as viewed along an axis of rotation of a driving force receiving member involved in Embodiment 20 of the present invention.

FIG. 44A and FIG. 44B are state diagrams after engagement of a driving force receiving member with a force output member involved in Embodiment 20 of the present invention.

FIG. 45 is a stereogram of a driving force receiving member involved in Embodiment 21 of the present invention.

FIG. 46 is a stereogram of a second unit after hiding a part of components involved in Embodiment 22 of the present invention.

FIG. 47 is a sectional view of a process cartridge with a second unit involved in Embodiment 22 of the present invention that is sectioned along a plane perpendicular to an axis of rotation of a photosensitive drum.

FIG. 48 is a schematic decomposition diagram of a first separation contact mechanism in a process cartridge and a process cartridge casing involved in the present invention.

FIG. 49 is a side view showing that a first separation contact mechanism is mounted in a process cartridge casing as viewed from left to right in a left-right direction of a process cartridge involved in the present invention.

FIG. 50 is a side view showing that a second separation contact mechanism is mounted in a process cartridge casing as viewed from left to right in a left-right direction of a process cartridge involved in the present invention.

FIG. 51 is a schematic decomposition diagram of a third separation contact mechanism in a process cartridge and a process cartridge casing involved in the present invention.

FIG. 52A to FIG. 52G are schematic diagrams showing movement processes of controlling, by a third separation contact mechanism in a process cartridge involved in the present invention, separation and contact of a developing roller and a photosensitive drum under an action of a separation control mechanism.

FIG. 53 is a schematic decomposition diagram of a fourth separation contact mechanism in a process cartridge and a process cartridge casing involved in the present invention.

FIG. 54 is a side view showing that a fourth separation contact mechanism is mounted in a process cartridge casing as viewed from left to right in a left-right direction of a process cartridge involved in the present invention.

FIG. 55 is a schematic decomposition diagram of a fifth separation contact mechanism in a process cartridge and a process cartridge casing involved in the present invention.

FIG. 56A and FIG. 56B are side views showing that a fifth separation contact mechanism is mounted in a process cartridge casing as viewed from left to right in a left-right direction of a process cartridge involved in the present invention.

FIG. 57A is a side view as viewed from left to right in a left-right direction before a separation contact mechanism is pressed after a process cartridge with the sixth separation contact mechanism reaches a mounting position.

FIG. 57B is a side view as viewed from left to right in a left-right direction after a separation contact mechanism is pressed after a process cartridge with the sixth separation contact mechanism reaches a mounting position.

FIG. 58A is a side view as viewed from left to right in a left-right direction before a separation contact mechanism is pressed after a process cartridge with the seventh separation contact mechanism reaches a mounting position.

FIG. 58B is a side view as viewed from left to right in a left-right direction after a separation contact mechanism is pressed after a process cartridge with the seventh separation contact mechanism reaches a mounting position.

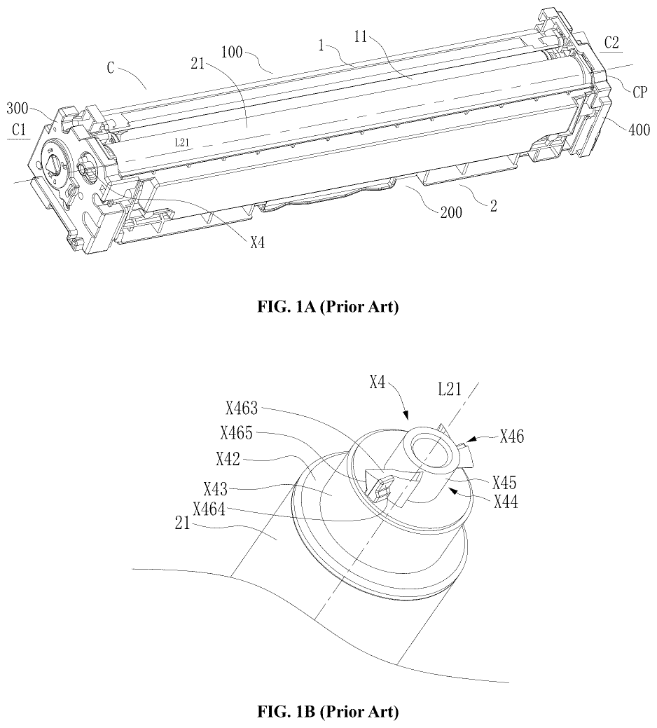

### DETAILED DESCRIPTION OF THE EMBODIMENTS

Embodiments of the present invention will be described in detail below with reference to the drawings. In order to facilitate the understanding, besides a driving force receiving member, numbers and structures of a process cartridge and members thereof mentioned in the patent application as mentioned in the background art will be directly referred to hereinafter.

It can be understood that the first rotating member 11 and/or the second rotating member 21 in the patent application in the background art may be directly or indirectly driven by the driving force receiving member X4; the process cartridge C may include the first unit 100 and the second unit 200 at the same time, or may only include any one of the first unit 100 and the second unit 200, a developer is accommodated in the first unit casing 1, an end with the driving force receiving member X4 is referred to as a driving end C1, the other end opposite to the above end is referred to as a non-driving end C2, a driving end cover/first end cover 300 is mounted at the driving end C1, the driving force receiving member X4 is exposed from the driving end C1, a non-driving end cover/second end cover 400 is mounted at the non-driving end C2, the first unit 100 and the second unit 200 may engage with each other through the first end cover 300 and the second end cover 400, or may engage with each other through pins, buckles, etc., and the first end cover 300 and the second end cover 400 may serve as a part of the first unit 100 or the second unit 200, or may serve as components independent of the first unit 100 or the second unit 200, as long as the first unit 100 and the second unit 200 can engage with each other; and the first rotating member 11 may be a developing roller, the second rotating member 21 may be a photosensitive drum, however, the first rotating member 11 and the second rotating member 21 may further be other components required to rotate in the process cartridge, such as a charging member 24 for charging the photosensitive drum, a supplying member 102 for supplying the developer to the developing roller, or a stirring member for stirring the developer, etc., as long as the driving force receiving member X4 can receive a driving force from a force output member arranged in an image forming apparatus and drive the rotating member to rotate, that is, the photosensitive drum 21, the charging member 24, the developing roller 11, the supplying member 102, the stirring member, etc. rotationally mounted in the process cartridge C may be referred to as the rotating member, the driving force receiving member X4 receives the driving force from the image forming apparatus so as to drive the rotating member to rotate, and therefore the engagement of the rotating member with the driving force receiving member X4 may be referred to as a rotating assembly.

When the process cartridge C operates, the photosensitive drum 21 makes contact with the developing roller 11, the developer is supplied to the photosensitive drum 21 by the developing roller 11, the driving force receiving member is represented as a number 4 below, a driving force receiving member 4 is fixedly mounted at one longitudinal tail end of the rotating member, and therefore the driving force receiving member 4 and the rotating member have the same axis of rotation.

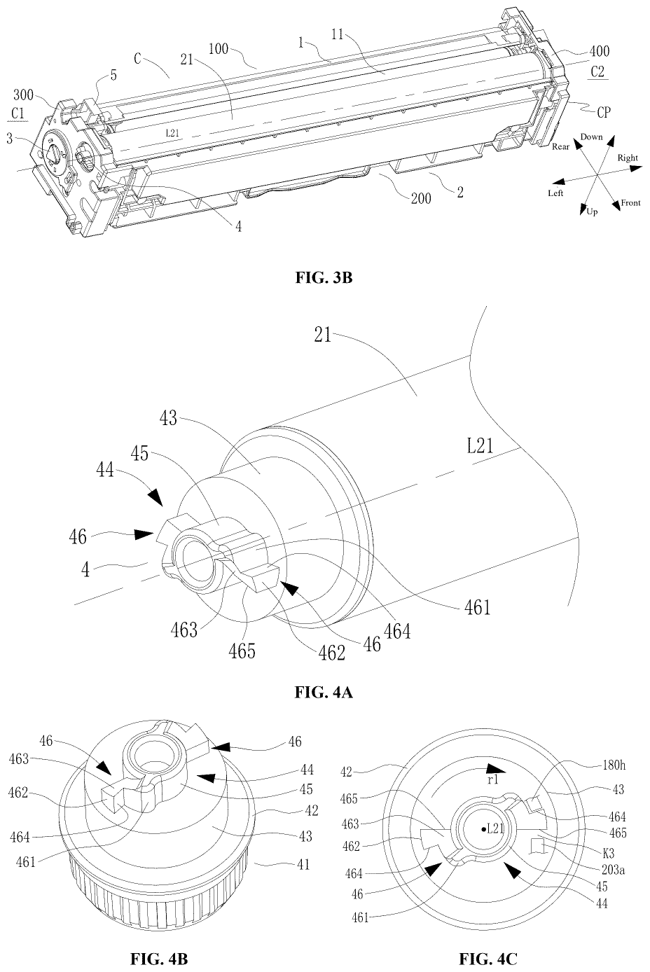

FIG. 3A and FIG. 3B are stereograms of the process cartridge involved in the present invention.

In order to facilitate the description below, it is defined here that a side, provided with the photosensitive drum 21 and the developing roller 11, in the process cartridge C is oriented towards a side, not provided with the photosensitive drum 21 and the developing roller 11, which is an upper side, a side opposite to the upper side is a lower side, a direction from the first unit 100 to the second unit 200 is a front side, a side opposite to the front side is a rear side, a side receiving the driving force is a left side, and a side opposite to the left side is a right side; and the process cartridge C is mounted to the image forming apparatus from top to bottom in a top-bottom direction, the left side is the driving end C1, the right side is the non-driving end C2, the first end cover 300 is mounted at the driving end C1, the second end cover 400 is mounted at the non-driving end C2, and a first driving force receiving member 3 (also referred to as “developing driving force receiving member 3”) for receiving the driving force for the developing roller 11 and the driving force receiving member 4 for receiving the driving force for the photosensitive drum 21 are both exposed from the first end cover 300.

The driving force receiving member 4 being directly mounted at a tail end of the photosensitive drum 21 is taken as an example for description below.

### [Force Output Member in Image Forming Apparatus]

In order to more clearly describe below, it is necessary to further describe the force output member 203 with reference to the drawings in the patent application (referred patent application) in the background art here.

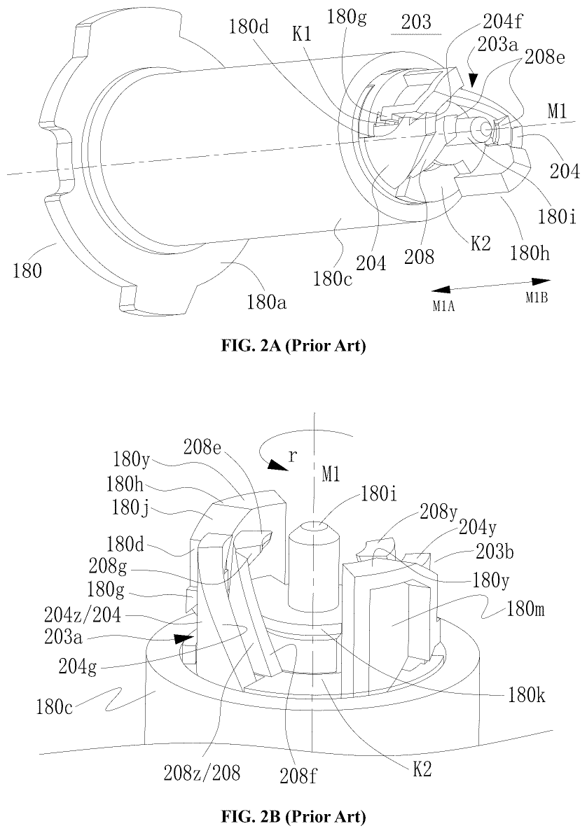

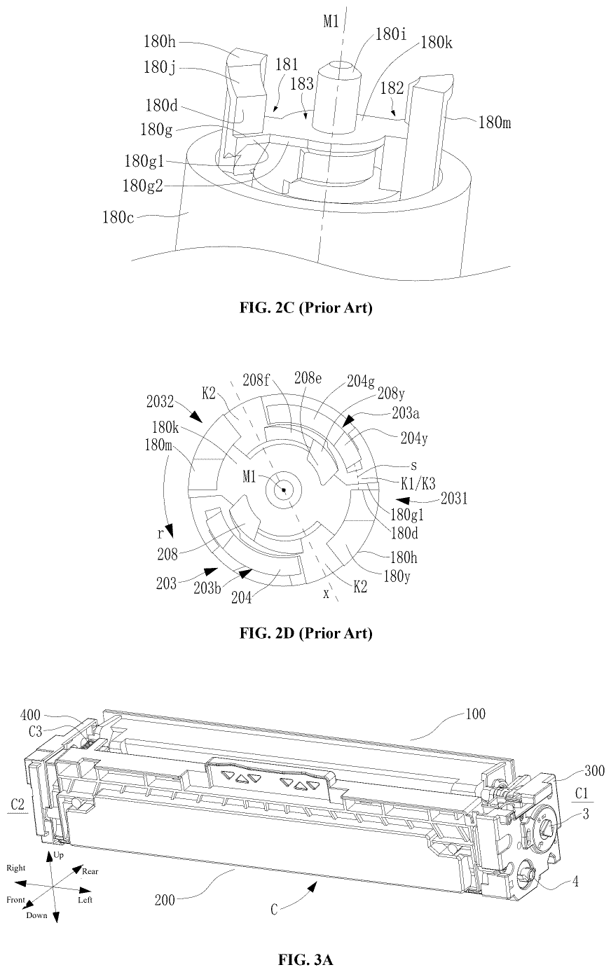

As shown in FIG. 2A to FIG. 2D in this patent application, a driving force output member 180 includes a cylindrical portion 180c, and a flange portion 180a and a driving portion 180h which are located at two ends of the cylindrical portion 180c respectively, and a braking force output member includes a first braking engagement member 204 and a second braking engagement member 208 which engage with each other. As shown in FIG. 48 in the referred patent application and FIG. 32 and FIG. 34B in this patent application, the driving force output member 180 and the braking force output member can rotate around the axis of rotation M1 in the same direction of rotation r, the braking force output member can rotate with the driving force output member 180, and before the process cartridge C is mounted to the image forming apparatus, the driving force output member 180 and the braking force output member are partially overlapped.

The driving force output member 180 includes a first driving force output portion 180h and a second driving force output portion 180m which are oppositely arranged in a radial direction of the force output member, and the braking force output member includes a first braking force output portion 203a and a second braking force output portion 203b which are oppositely arranged in the radial direction of the force output member. As shown in FIG. 2D, the first driving force output portion 180h, the first braking force output portion 203a, the second driving force output portion 180m and the second braking force output portion 203b are sequentially arranged in the direction of rotation.

As shown in FIG. 2D, a parting line x that passes through the axis of rotation M1 and positions between the first braking force output portion 203a and the second driving force output portion 180m and between the first driving force output portion 180h and the second braking force output portion 203b is made. In FIG. 2D, the force output member 203 is divided by the parting line x into a first force output portion 2031 and a second force output portion 2032, wherein the first force output portion 2031 includes the first driving force output portion 180h and the first braking force output portion 203a, and the second force output portion 2032 includes the second driving force output portion 180m and the second braking force output portion 203b. The first driving force output portion 180h and the second driving force output portion 180m have the same structure, the first braking force output portion 203a and the second braking force output portion 203b have the same structure, and engaging processes between the driving force receiving member 4 and the first force output portion 2031 and between the driving force receiving member and the second force output portion 2032 are the same.

In order to facilitate the description, the engaging process between the first force output portion 2031 and the driving force receiving member 4 is taken as an example for description. Furthermore, the first driving force output portion 180h in the first force output portion 2031 is a driving force output portion/driving portion 180h for short, the first braking force output portion 203a in the first force output portion 2031 is a braking portion 203a for short, the braking portion 203a is located on a downstream side of the driving portion 180h in the direction of rotation r, the driving portion 180h and the braking portion 203a can rotate around the axis of rotation M1 in the same direction, the braking portion 203a can rotate with the driving portion 180h, and before the process cartridge is mounted to the image forming apparatus, the driving portion 180h and the braking portion 203a are partially overlapped.

The braking portion 203a includes the first braking engagement member 204 and the second braking engagement member 208, and the first braking engagement member 204 is located on an outer side of the second braking engagement member 208 in the radial direction of the force output member 203. As shown in FIGS. 43A and 43B in the referred patent application, the first braking engagement member 204 and the second braking engagement member 208 engage with each other through a rotation stop recess 204c and a rotation stop projection 208c, and therefore the first braking engagement member 204 and the second braking engagement member 208 can rotate around the axis M1 together.

Furthermore, the force output member 203 further includes a first spring (drum drive coupling spring) 210 and a second spring (braking engagement spring) 211, the first spring 210 abuts against a brake transmission member 207, a flange portion 207a of the brake transmission member 207 abuts against the second braking engagement member 208, and meanwhile, a projection 207f of the brake transmission member 207 further abuts against a contact surface 180f (as shown in FIGS. 44A and 44B in the referred patent application) of the driving force output member; and the second spring 211 abuts against a flange portion 204a of the first braking engagement member 204. Along the axis M1, the first braking engagement member 204, the second braking engagement member 208 and the driving portion 180h are arranged to be capable of retracting and extending along the axis M1, that is, to move in directions M1A and M1B in FIG. 48 in the referred patent application, wherein, the first braking engagement member 204 and the second braking engagement member 208 can retract and extend along the axis M1 at the same time, both of which can also retract and extend along the axis M1 respectively in some image forming apparatuses; when the first braking engagement member 204 moves in the direction (direction close to the flange portion 180a) M1A along the axis M1, after the rotation stop recess 204c and the rotation stop projection 208c disengage from each other, the first braking engagement member 204 can freely rotate around the axis M1; and when the second braking engagement member 208 moves in the direction M1A along the axis M1, the first braking engagement member 204 will also move in the direction M1A along the axis M1 through the rotation stop recess 204c and the rotation stop projection 208c, and finally, the first braking engagement member 204 and the second braking engagement member 208 can both freely rotate around the axis M1.

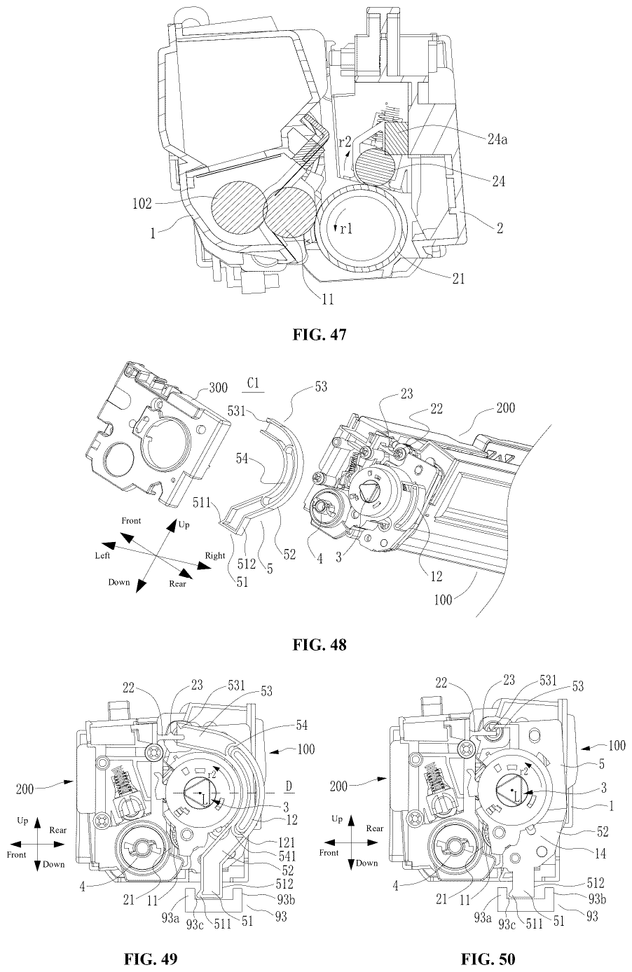

Furthermore, as shown in FIG. 47 in the referred patent application and FIG. 2D in the present patent application, the second braking engagement member 208 further has an inward projection 208e projecting inwards in a radial direction of a coupling engaging portion 208b, and the inward projection 208e is located at a free end of the second braking engagement member 208 in the direction M1B (as shown in FIG. 48 in the referred patent application) opposite to the direction M1A. As shown in FIG. 2A to FIG. 2D, a driving force output surface 180d is located on the driving portion 180h, the driving portion 180h is opposite to the first braking engagement member 204 in the direction of rotation of the force output member 203, that is, a circle is made in a plane perpendicular to the axis of rotation M1 with a point where the axis of rotation M1 passes as a center of the circle, and the circle will pass through at least a part of the driving portion 180h and at least a part of the first braking engagement member 204 at the same time.

Further referring to FIG. 2A to FIG. 2D, the second braking engagement member 208 has the inward projection 208e projecting towards the axis of rotation M1, furthermore, in the direction of rotation r of the force output member 203, the first braking engagement member 204 has an outer output surface 204g located on a downstream side of a first braking engagement member body 204z, and the second braking engagement member 208 has an inner output surface 208f located on a downstream side of a second braking engagement member body 208z; the inward projection 208e projects inwards or towards the axis of rotation M1 in a radial direction of the second braking engagement member body 208z, the inward projection 208e has a plane 208g located on a downstream side in the direction of rotation r, and the plane 208g is adjacent to the inner output surface 208f; and furthermore, as shown in FIG. 2B, along the axis of rotation M1, the driving portion 180h has a driving tail end surface 180y located at a tail end, the first braking engagement member 204 has a first braking tail end surface 204y located at a tail end, the second braking engagement member 208 has a second braking tail end surface 208y located at a tail end, and the tail ends refer to ends, farthest from the flange portion 180a, of the driving portion 180h, the first braking engagement member 204 and the second braking engagement member 208.

When the driving portion 180h and the braking portion 203a get close to each other, the driving portion 180h and the braking portion 203a cannot cling to each other, as shown in FIG. 2D, a gap is formed between the first braking tail end surface 204y and the driving portion 180h in the direction of rotation r, a minimum value of the gap is s, that is, a shortest distance between the first braking tail end surface 204y and the driving portion 180h is s.

As shown in FIG. 2C, the two driving portions 180h are oppositely arranged in the radial direction of the driving force output member 180, the driving force output member 180 further includes a connecting member 180k connecting the two driving portions, the connecting member 180k includes an intermediate plate 183, and a first connecting member 181 and a second connecting member 182 which are located on two radial sides in a radial direction of the intermediate plate 183 respectively, a following positioning boss 180i projects from the intermediate plate 183 along the axis of rotation M1, and the first connecting member 181 and the second connecting member 182 have the same structure, and are connected with the driving portion respectively.

Furthermore, a lower projecting portion 180g is arranged on a surface (driving force output surface) 180d of a side, facing the first braking engagement member 204, of the driving portion 180h, the driving portion 180h further has an inclined surface 180j adjacent to the driving force output surface 180d in the direction of rotation r, an upper projecting portion 204f is arranged on a surface of a side, facing the driving portion 180h, of the first braking engagement member 204, before the process cartridge 100 is mounted, the driving portion 180h and the first braking engagement member 204 get close to each other in the direction of rotation r, and the upper projecting portion 204f and the lower projecting portion 180g are opposite/overlapped along the axis of rotation M1.

On the whole, the lower projecting portion 180g and the first connecting member 181 are integrally formed, the driving force output surface 180d projects from the lower projecting portion 180g along the axis of rotation M1, the lower projecting portion 180g further may be appraised to project from the first connecting member 181/driving force output surface 180d in the direction of rotation r, and a tail end of the lower projecting portion 180g is formed as a front surface 180g1 capable of rotating with the driving portion 180h; and furthermore, the first connecting member 181 further has a sub front surface 180g2 located on a downstream side of the direction of rotation in the direction of rotation r, the front surface 180g1 is connected with the sub front surface 180g2, and the front surface 180g1 and the sub front surface 180g2 are both located at a downstream tail end of the first connecting member 181, and therefore the front surface 180g1 and the sub front surface 180g2 may be collectively referred to as a downstream tail end surface of the first connecting member 181.

The force output member 203 has a first space K1, a second space K2 and a third space K3 in the direction of rotation r, wherein the first space K1 refers to a space between the front surface 180g1 and the braking portion 203a, the second space K2 refers to a space between the braking portion 203a and the driving portion 180h located on the downstream side of the braking portion, specifically, as shown in FIG. 2D, the second space K2 refers to a space between the first braking force output portion 203a and the second driving force output portion 180m, or a space between the second braking force output portion 203b and the first driving force output portion 180h, and the third space K3 refers to a space between the driving portion 180h/driving force output surface 180d and the first braking engagement member 204; and as shown in FIG. 2D, the second space K2 is larger than the first space K1/third space K3 in the direction of rotation r.

As shown in FIG. 4A, the driving force receiving member 4 involved in the present invention has an axis of rotation L21, including a connecting portion 41, a base tray 42, a substrate 43 and an engaging portion 44, the connecting portion 41, the base tray 42, the substrate 43 and the engaging portion 44 are sequentially arranged along the axis of rotation L21, the connecting portion 41 directly or indirectly engages with the rotating member to be used for transmitting the driving force to the rotating member to drive the rotating member to rotate, the base tray 42 abuts against the rotating member to position the driving force receiving member 4 relative to the rotating member, the substrate 43 extends from the base tray 42, and the engaging portion 44 extends from the substrate 43 in a direction away from the base tray 42; and as a simplified structure, the base tray 42 may be omitted, the substrate 43 directly extends from the connecting portion 41, and more simply, the substrate 43 may also be omitted, and the engaging portion 44 extends from the connecting portion 41.

The structure of the engaging portion 44 will be described below, and other structures of the driving force receiving member 4 will not limited here. In order to more clearly describe the structure of the driving force receiving member involved in the present invention, only the driving force receiving member 4 is described below; however, it should be understood that the driving force receiving member 4 can be suitable for various rotating members in the process cartridge.

### [Driving Force Receiving Member]

### Embodiment 1

As shown in FIG. 4A to FIG. 4C, a photosensitive drum 21 has an axis of rotation L21, a driving force receiving member 4 includes a connecting portion 41 (as shown in FIG. 4B), a base tray 42, a substrate 43 and an engaging portion 44, the driving force receiving member 4 is connected with the photosensitive drum 21 in a manner that the connecting portion 41 is embedded into the photosensitive drum 21, the base tray 42 abuts against the photosensitive drum 21 to position the driving force receiving member 4 relative to the photosensitive drum 21, the substrate 43 extends from the base tray 42, and the engaging portion 44 extends from the substrate 43 in a direction away from the base tray 42; and as a simplified structure, the base tray 42 may be omitted, the substrate 43 directly extends from the connecting portion 41, and more simply, the substrate 43 may also be omitted, and the engaging portion 44 extends from the connecting portion 41.

The structure of the engaging portion 44 will be described below, and other structures of the driving force receiving member 4 will not limited here.

The engaging portion 44 includes a central pillar 45 and driving force receiving portions 46 extending outwards in a radial direction of the central pillar 45, an axis of rotation L21 penetrates through the central pillar 45, and the two driving force receiving portions 46 are oppositely arranged on a periphery of the central pillar 45 radially. As shown in FIG. 4A and FIG. 4B, each driving force receiving portion 46 includes a base 461 connected with the central pillar 45 and a convex block 462 located on a radial outer side of the base 461, the convex block 462 is located on the radial outer side of the base 461 in a radial direction of the driving force receiving member 4, a guide surface 463 extends from the base 461 to the convex block 462, the convex block 462 has a first surface/driving surface 464 and a second surface/braking surface 465 adjacent to the guide surface 463, and the first surface 464 and the second surface 465 are both parallel to the axis of rotation L21.

As a process cartridge C is mounted towards an image forming apparatus, the guide surface 463 guides a braking portion 203a to move relative to a driving portion 180h, so that the corresponding driving force receiving portion 46 enters a position between the driving portion 180h and the braking portion 203a, that is, the driving force receiving portion 46 enters a first space K3, as shown in FIG. 4C, a driving force output surface 180d abuts against the first surface 464, the second surface 465 is spaced from the braking portion 203a, when the driving portion 180h rotates in a direction of rotation r, a driving force is transmitted to an engaging portion 44 through the first surface 464, and therefore the photosensitive drum 21 is driven to rotate around the axis of rotation L21.

Since the second surface 465 is separated from the braking portion 203a, that is, the driving force receiving member 4 is not necessary to be braked when stopping operating, and in the process where the cartridge C returns to an inoperative state from an operating state or the photosensitive drum 21 returns to a non-rotating state from a rotating state, the braking portion 203a does not apply an acting force/braking force to the driving force receiving member 4 in a circumferential direction of the photosensitive drum 21, and equivalently, the braking portion 203a is disabled, which is conducive to relieving abrasion generated when the driving force receiving member 4 operates; and furthermore, after the driving force receiving member 4 involved in the embodiment is adopted, the braking portion 203a in the image forming apparatus does not need to return to a position where the braking portion and the driving portion 180h get close to each other or are partially overlapped, which is conducive to simplifying the structure of the image forming apparatus, as for the driving portion 180h and the braking portion 203a which are already in a separated state, a driving force receiving member 4 of a next process cartridge may not have a guide surface 463, and therefore the structure of the process cartridge C may also be simplified.

### Embodiment 2

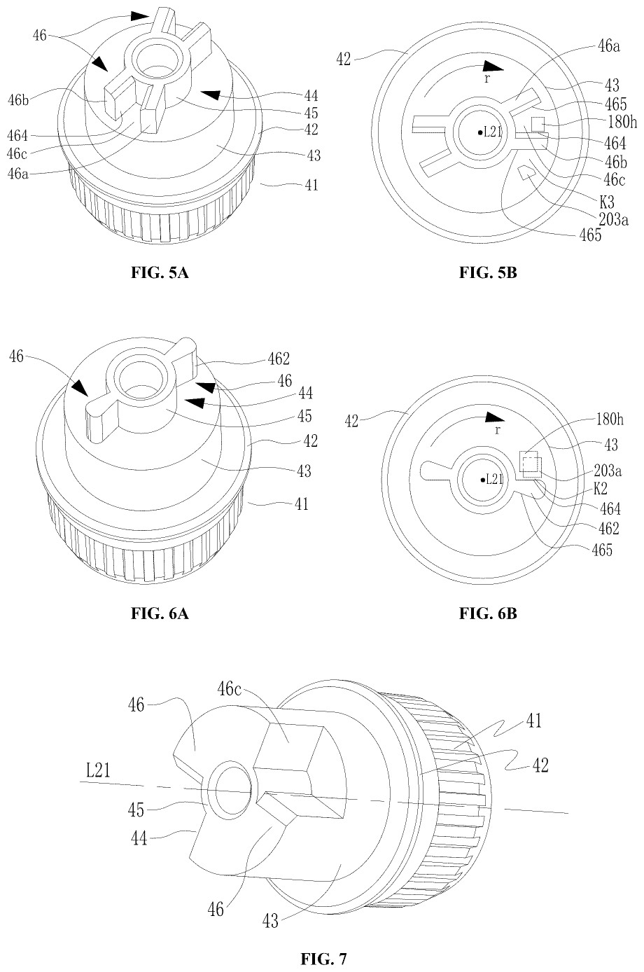

As shown in FIG. 5A and FIG. 5B, in order to facilitate the understanding, structures the same as those of the above first driving force receiving member 4 will adopt the same numbers. The structure of each driving force receiving portion 46 in the embodiment is different from that in Embodiment 1. As shown in figures, the driving force receiving portion 46 in this embodiment is formed as at least one pair of convex blocks 46a/46b spaced from each other, the convex blocks 46a/46b extend from a central pillar 45 in a direction away from an axis of rotation L21, a driving space 46c is formed therebetween, and each convex block has a first surface 464 and a second surface 465 which are opposite to each other; and as shown in FIG. 5B, the second surface 465 of the convex block 46a and the first surface 464 of the convex block 46b are formed as edges of the driving space 46c, when a process cartridge C is mounted, a driving portion 180h enters the driving space 46c, a braking portion 203a is located outside the driving space 46c, or the second convex block 46b enters a third space K3, when the process cartridge C operates, the driving portion 180h abuts against the first surface 464 of the convex block 46b, the braking portion 203a is away from the second surface 465 of the convex block 46b, and a driving force receiving member 4 rotates around the axis of rotation L21 in a direction r under a driving action of the driving portion 180h.

Different from Embodiment 1, the driving force receiving member 4 involved in this embodiment has a braked function, specifically, when the driving portion 180h stops applying a driving force to the first surface 464 of the convex block, a photosensitive drum 21/driving force receiving member 4 may continue to rotate in the direction r under an inertia action, at this moment, the second surface 465 of the convex block 46a will abut against the driving portion 180h, since the driving portion 180h has stopped rotating, the driving force receiving member 4 is braked under the braking action of the driving portion 180h, that is, in the process where the process cartridge C returns to an inoperative state from an operating state or the photosensitive drum 21 returns to a non-rotating state from a rotating state, the braking portion 203a does not apply an acting force/braking force to the driving force receiving member in a circumferential direction of the photosensitive drum 21, equivalently, the braking portion 203a is disabled, and braking of the driving force receiving member 4 is completed through abutment between the driving portion 180h and the convex block 46a.

Similarly, after the driving force receiving member 4 involved in this embodiment is adopted, the braking portion 203a in an image forming apparatus does not need to return to a position where the braking portion and the driving portion 180h get close to each other or are partially overlapped, which is conducive to simplifying the structure of the image forming apparatus; and as for the driving portion 180h and the braking portion 203a which are already in a separated state, a driving force receiving member 4 of a next process cartridge may not have a guide surface 463, and therefore the structure of the process cartridge C may also be simplified.

Wherein, in order to facilitate the distinguishment, the convex block 46a may be referred to as the first convex block, the convex block 46b may be referred to as the second convex block, and the first convex block 46a is located on an upstream side of the second convex block 46b in the direction of rotation r of the photosensitive drum 21/driving force receiving member 4; and it can be understood that as shown in FIG. 5B, when the process cartridge C operates in the image forming apparatus, a minimum distance between the second surface 465 of the first convex block and the driving portion 180h is less than a minimum distance between the second surface 465 of the second convex block and the braking portion 203a, so as to ensure that the first convex block 46a abuts against the driving portion 180h and the second convex block 46b cannot abut against the braking portion 203a in the process where the driving force receiving member 4 is braked.

### Embodiment 3

As shown in FIG. 6A and FIG. 6B, in order to facilitate the understanding, structures the same as those of the above first driving force receiving member 4 will adopt the same numbers.

The structure of each driving force receiving portion 46 in this embodiment is different from that in Embodiment 1. As shown in FIG. 6A, in this embodiment, the driving force receiving portion 46 is simplified into at least one independent convex block 462, the convex block 462 also has a first surface 464 and a second surface 465 which are opposite, and the first surface 464 is located on an upstream side of the second surface 465 in a direction of rotation r; and when a process cartridge C is mounted at a preset position of an image forming apparatus, the first surface 464 reaches a downstream space K2 (second space K2) of a braking portion 203a, and at this moment, the first surface 464 is opposite to the braking portion 203a.

When the process cartridge C starts to operate, the braking portion 203a rotates with a driving portion 180h, at this moment, the braking portion 203a abuts against the first surface 464 and drives a braking force receiving member 4 to rotate in the direction of rotation r, and in the same way as Embodiment 1, the driving force receiving member 4 in this embodiment also does not need to be braked by the braking portion when stopping operating, which is conducive to relieving abrasion generated when the driving force receiving member 4 operates; and in the process where the process cartridge C returns to an inoperative state from an operating state or a photosensitive drum 21 returns to a non-rotating state from a rotating state, the driving portion 180h does not apply an acting force/braking force to the driving force receiving member in a circumferential direction of the photosensitive drum 21, and equivalently, the driving portion 180h is disabled.

The structure of the driving force receiving member 4 in this embodiment is simplified, meanwhile, a contact surface between the driving force receiving portion 46 and a force output member 203 is increased, which is conducive to improving the engaging stability of the driving force receiving portion 46 and the force output member 203 and the force bearing stability of the driving force receiving portion 46, and the driving force receiving portion 46 and the force output member 203 are not prone to disengagement.

Since the second space K2 is the largest, the driving force receiving portion 46 is more likely to enter the second space K2 compared to the driving force receiving portion 46 entering a first space K1 or a third space K3, the engaging efficiency of the driving force receiving member 4 and the force output member 203 can further be improved by the adoption of the solution that the braking portion 203a drives the driving force receiving member 4 accordingly, thereby preventing engaging dislocation of the driving force receiving member 4 and the force output member 203.

### Embodiment 4

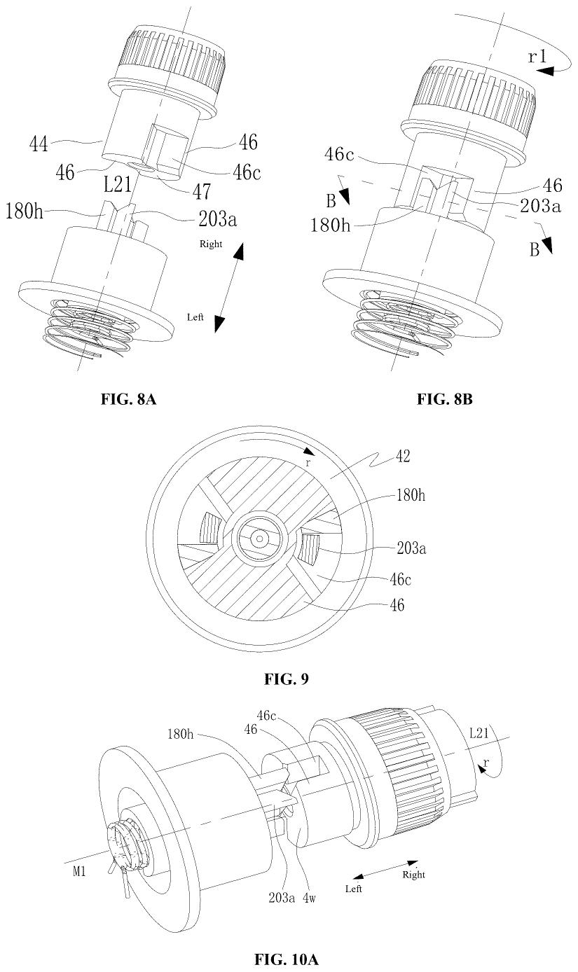

As shown in FIG. 7, FIG. 8A, FIG. 8B and FIG. 9, a driving force receiving member 4 in this embodiment still includes a connecting portion 41, a base tray 42, a substrate 43 and an engaging portion 44, the connecting portion 41 is connected with a photosensitive drum, the base tray 42 abuts against the photosensitive drum, the driving force receiving member 4 is fixed to the photosensitive drum 21, the substrate 43 extends from the base tray 42, and the engaging portion 44 extends from the substrate 43 in a direction away from the base tray 42; and in the same way as Embodiment 1, at least one of the base tray 42 and the substrate 43 may be omitted. The engaging portion 44 includes a central pillar 45 and driving force receiving portions 46 extending outwards in a radial direction of the central pillar 45, an axis of rotation L21 penetrates through the central pillar 45, and the two driving force receiving portions 46 are oppositely arranged on a periphery of the central pillar 45 radially; under the condition that the substrate 43 is arranged, preferably, the driving force receiving portions 46 and the substrate 43 are integrally formed, two driving spaces 46c are formed between the two driving force receiving portions 46 in a circumferential direction of the driving force receiving member 4, each driving space 46c can accommodate a part of a force output member 203 in an image forming apparatus at the same time, at least one part of a first force output portion 2031 enters one driving space 46c, and at least one part of a second force output portion 2032 enters the other driving space 46c.

As shown in FIG. 8A, the photosensitive drum 21 with the driving force receiving member 4 is mounted with a process cartridge C, in the process where the process cartridge C is mounted towards the image forming apparatus, if a driving portion 180h and a braking portion 203a are just opposite to the driving spaces 46c, the driving portion 180h and the braking portion 203a will directly enter the driving spaces 46c, and if the driving portion 180h and the braking portion 203a cannot be completely opposite to the driving spaces 46c, the driving portion 180h and the braking portion 203a can finally enter the driving spaces 46c with rotation of the driving portion 180h/braking portion 203a.

The braking portion 203a outputs a driving force to the driving force receiving portions 46 in a direction of rotation r, so as to drive the driving force receiving member 4 to rotate; in the same way as Embodiment 2, when the braking portion 203a stops transmitting the driving force to the driving force receiving portions 46, the driving portion 180h will brake the driving force receiving member 4 continuing to rotate, that is, when the driving force receiving member 4 involved in this embodiment is adopted in the process cartridge C, functions of the driving portion 180h and the braking portion 203a in the image forming apparatus will be exchanged, that is, in the operating process of the process cartridge C, the braking portion 203a in the image forming apparatus has a driving effect, and in the process where the process cartridge C needs to return to an inoperative state or the photosensitive drum 21 returns to a non-rotating state from a rotating state, the driving portion 180h in the image forming apparatus has a braking effect, so that the structures of the driving force receiving member and the image forming apparatus are both simplified, and the driving force receiving portions 46 can also easily enter a second space K2.

### Embodiment 5

As shown in FIG. 10A and FIG. 10B, in this embodiment, at least one of a driving portion 180h and a braking portion 203a in an image forming apparatus is arranged to be capable of extending and retracting along an axis of rotation M1, and a driving space 46c is still formed between two driving force receiving portions 46 of a driving force receiving member 4; and when the driving force receiving member 4 is mounted with a process cartridge C, a tail end surface 4w of the driving force receiving member 4 will abut against one of the driving portion 180h and the braking portion 203a, or the tail end surface 4w abuts against the driving portion 180h and the braking portion 203a at the same time, and therefore at least one of the driving portion 180h and the braking portion 203a is pressed to retract into the image forming apparatus.

As shown in FIG. 10B, when the driving portion 180h or the braking portion 203a enters the driving spaces 46c, the driving portion 180h or the braking portion 203a will drive the driving force receiving member 4 to rotate around an axis of rotation L21 in a direction r with start of the image forming apparatus; and when the driving portion 180h and the braking portion 203a are pressed at the same time, the driving portion 180h and the braking portion 203a start to rotate at the same time with start of the image forming apparatus, however, the driving force receiving member 4 is not driven till one of the driving portion 180h and the braking portion 203a enters the corresponding driving space 46c.

The driving force receiving member 4 in this embodiment can be driven by the driving portion 180h or the braking portion 203a, when the driving force receiving member 4 is driven by the driving portion 180h, the braking portion 203a is pressed by the tail end surface 4w to retract, and equivalently, the braking portion 203a is disabled; in the process where the process cartridge C operates and the process cartridge C returns to an inoperative state from an operating state, the braking portion 203a does not act, and the braking portion 203a does not transmit an acting force to the driving force receiving member in a circumferential direction of a photosensitive drum 21; when the driving force receiving member 4 is driven by the braking portion 203a, the driving portion 180h is pressed by the tail end surface 4w to retract, and equivalently, the driving portion 180h is disabled; in the process where the process cartridge C operates, and the process cartridge C returns to the inoperative state from the operating state or the photosensitive drum 21 returns to a non-rotating state from a rotating state, the driving portion 180h does not transmit the acting force to the driving force receiving member 4 in the circumferential direction of the photosensitive drum 21, that is, the driving portion 180h does not act; and similarly, the structures of the driving force receiving member 4 and the image forming apparatus are both simplified.

It can be shown from the above embodiment that the driving portion 180h or the braking portion 203a can transmit a driving force to the driving force receiving member 4, when the driving portion 180 is adopted to transmit the driving force to the driving force receiving member 4, and in the process where the process cartridge returns to the inoperative state from the operating state or the photosensitive drum 21 returns to the non-rotating state from the rotating state, the braking portion 203a does not transmit the acting force to the driving force receiving member in the circumferential direction of the photosensitive drum 21, at this moment, the braking portion 203a is disabled, specifically, the braking portion may be disabled in a manner that the braking portion 203a is away from the corresponding driving force receiving portion 46 in the driving force receiving member 4 in the direction of rotation r, or the braking portion 203a is pressed by the tail end surface 4w of the driving force receiving member 4 to a retracted state along the axis of rotation L21, and similarly, the disabling manner is also suitable for the driving portion 180h.

In order to facilitate the understanding, all components in the following embodiment and components with functions the same as those of the above embodiment will adopt the same names and numbers.

### Embodiment 6

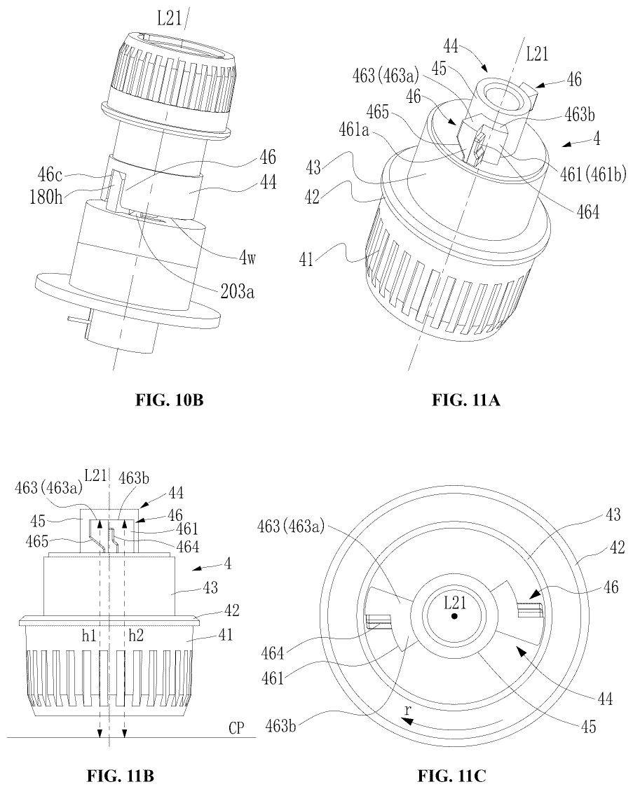

As shown in FIG. 11A, FIG. 11B and FIG. 11C, an engaging portion 44 includes a central pillar 45 and driving force receiving portions 46 extending outwards in a radial direction of the central pillar 45, an axis of rotation L21 penetrates through the central pillar 45, and one or a plurality of driving force receiving portions 46 may be arranged in a circumferential direction of the central pillar 45; and furthermore, one or the plurality of driving force receiving portions 46 may further be appraised as formed by extending from a substrate 43 along the axis of rotation L21.

One driving force receiving portion 46 is taken as an example. The driving force receiving portion 46 includes a base 461 connected with the central pillar 45, a driving surface 464, a braking surface 465 and a contact surface 463, wherein the above surfaces are arranged on the base 461, and the driving surface 464 and the braking surface 465 are oppositely arranged in a direction of rotation of the driving force receiving member 4. When the driving force receiving member 4 is mounted towards an image forming apparatus with a process cartridge C, the contact surface 463 abuts against at least one of a coupling engaging portion 204b of a first braking engagement member 204 and a coupling engaging portion 208b of a second braking engaging member 208, so that the driving force receiving portion 46 reaches a position where a driving force output surface 180d is opposite to the driving surface 464, and when a force output member 203 rotates, the driving force receiving member 4/driving force receiving portion 46 rotates in the direction r shown in FIG. 11C.

The base 461 includes a first portion 461a and a second portion 461b which are adjacent in the direction of rotation of the driving force receiving member 4, wherein the driving surface 464 and the braking surface 465 are located on the first portion, the contact surface 463 extends from the first portion 461a and the second portion 461b at the same time, the first portion 461a projects farther than the second portion 461b in a radial direction of the driving force receiving member 4, and preferably, the first portion 461a and the second portion 461b are integrally formed.

In this embodiment, the contact surface 463 is formed as a tail end surface of the base 461, as shown in FIG. 11B, when viewed in a direction perpendicular to the axis of rotation L21, the contact surface 463 is perpendicular to the axis of rotation L21, specifically, in the direction of rotation of the driving force receiving member 4, the contact surface 463 includes a first contact surface 463a corresponding to the first portion 461a and a second contact surface 463b corresponding to the second portion 461b, and the first contact surface 463a and the second contact surface 463b are both perpendicular to the axis of rotation L21, so that the structure of the driving force receiving portion 46 may be simplified, which is conducive to improving the production efficiency of the driving force receiving portion 46 and the driving force receiving member 4 including the driving force receiving portion 46.

When the process cartridge C with the driving force receiving member 4 is mounted, the contact surface 463 abuts against a tail end of a braking portion 203a (first braking engaging member 204 and second braking engagement member 208), as the process cartridge C continues to be mounted, the braking portion 203a is pressed into the image forming apparatus, the first braking engagement member 204 disengages from a brake transmission member 207 in the patent application in the background art, the driving surface 464 reaches a position where the driving surface is opposite to a driving force output surface 180d, and the braking surface 465 is not opposite to the braking portion 203a. When the process cartridge C stops operating, the driving force output surface 180d does not output a driving force to the driving surface 464. In this embodiment, the contact surface 463 has the effect of pressing the braking portion 203a into the image forming apparatus and then guiding the driving force receiving member 4 to engage with the force output member, and therefore the contact surface 463 may also be referred to as a pressing surface or a guide surface. In the operating process of the process cartridge C, the braking portion 203a may be arranged either to apply a braking force to the braking surface 465, or not to apply the braking force to the braking surface 465.

When viewed in the direction perpendicular to the axis of rotation L21, the first contact surface 463a and the second contact surface 463b may be aligned or staggered, and when the two are staggered, a height difference will be formed between the first contact surface 463a and the second contact surface 463b. In the mounting process of the process cartridge C, the braking portion 203a is still pressed towards the inside of the image forming apparatus by the first contact surface 463a and the second contact surface 463b, however, since the first contact surface 463a and the second contact surface 463b are still arranged as planes perpendicular to the axis of rotation L21, the structure is still conducive to improving the production efficiency of the driving force receiving portion 46 and the driving force receiving member 4 including the driving force receiving portion 46 compared to an existing helical guide surface X463.

Preferably, when viewed in the direction perpendicular to the axis of rotation L21, the first contact surface 463a and the second contact surface 463b are aligned. More preferably, when viewed in the direction perpendicular to the axis of rotation L21, the first contact surface 463a and the second contact surface 463b are connected into a whole, that is, a tail end surface of the driving force receiving portion 46 is formed by the first contact surface 463a and the second contact surface 463b together, and the tail end surface is perpendicular to the axis of rotation L21. Based on that a process cartridge casing is located on a surface CP, farthest from a driving end C1, of a non-driving end C2, when measured along the axis of rotation L21, a distance between the first contact surface 463a and the surface CP is h1, a distance between the second contact surface 463b and the surface CP is h2, and h1=h2, so that the structure of the driving force receiving portion 46 can be simplified, which is conducive to improving the production efficiency of the driving force receiving portion 46 and the driving force receiving member 4 including the driving force receiving portion 46.

### (Variant Structure 1)

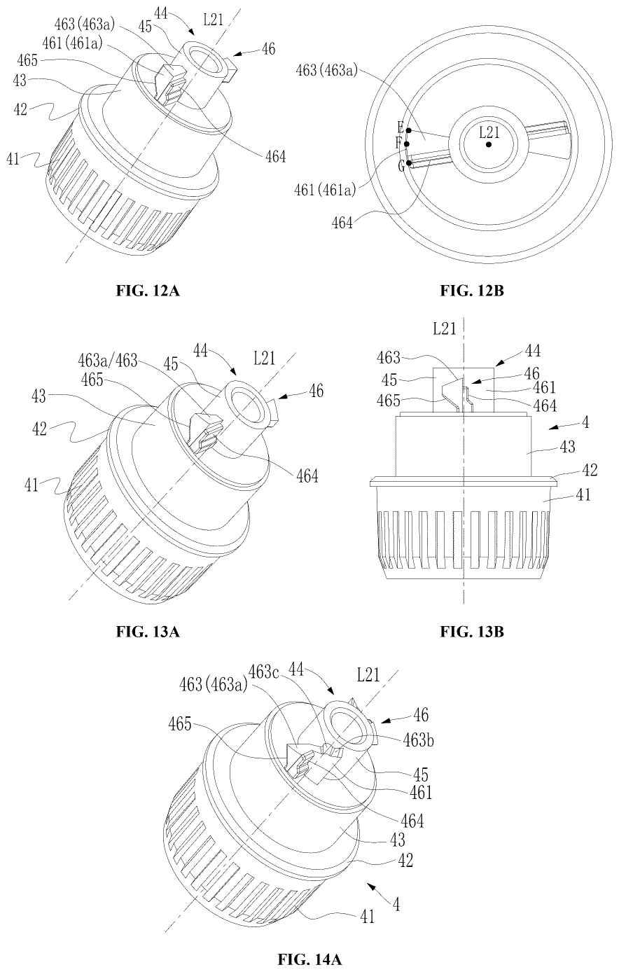

As shown in FIG. 12A and FIG. 12B, in the direction of rotation of the driving force receiving member 4, the guide surface/contact surface 463a is located on a side of the driving surface 464. Specifically, in the direction of rotation of the driving force receiving member 4, a starting position of the extension of the guide surface/contact surface 463a is located on a downstream side of the first surface/driving surface 464. The second portion 461b is cut off, the first portion 461a is retained, and thus the overall structure of the driving force receiving portion 46 is further simplified. Similarly, the tail end surface 463a of the first portion 461a is the contact surface along the axis of rotation L21, and the contact surface 463a is further perpendicular to the axis of rotation L21. The contact surface 463a, the driving surface 464 and the braking surface 465 all extend to a tail end of the base 461 in the radial direction of the driving force receiving portion 4. As shown in FIG. 12B, outermost points in the radial direction of the contact surface 463a, the braking surface 465 and the driving surface 464 are E, F and G respectively in the radial direction of the driving force receiving member 4, and distances between the axis of rotation L21 and the points E, F and G are equal, thereby improving the production efficiency of the driving force receiving portion 46 and the driving force receiving member 4 including the driving force receiving portion 46.

### (Variant Structure 2)

As shown in FIG. 13A and FIG. 13B, similar to the above variant structure 1, in the direction of rotation of the driving force receiving member 4, a starting position of the extension of the guide surface/contact surface 463a is located on a downstream side of the first surface/driving surface 464. The tail end surface 463a of the first portion 461a is arranged not to be perpendicular to the axis of rotation L21, but to be a slope inclined relative to the axis of rotation L21 or a helical surface extending in the direction of rotation of the driving force receiving member 4, the tail end surface 463a, the driving surface 464 and the braking surface 465 all extend to the tail end of the base 461 in the radial direction of the driving force receiving member 4, and distances between the axis of rotation L21 and outermost points in the radial direction of the contact surface 463a, the braking surface 465 and the driving surface 464 respectively are equal, thereby improving the production efficiency of the driving force receiving portion 46 and the driving force receiving member 4 including the driving force receiving portion 46.

### Embodiment 7

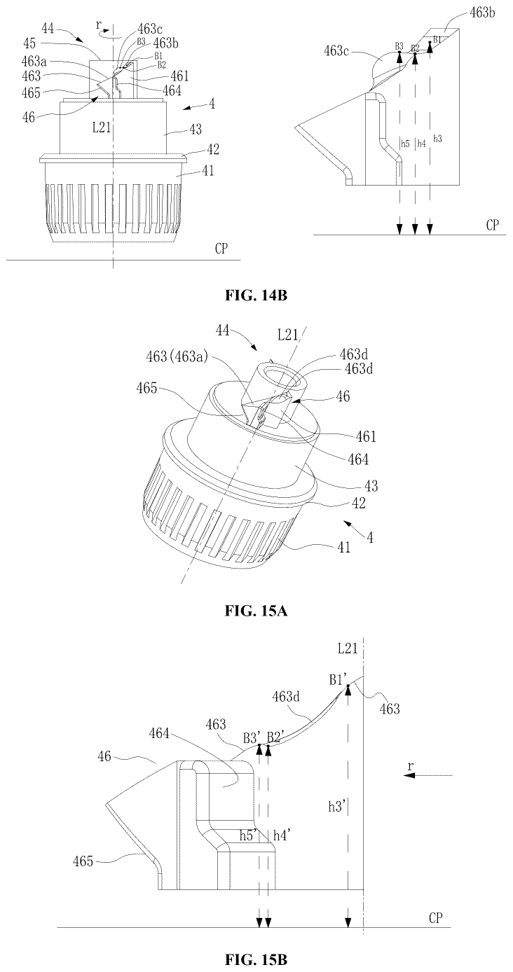

Different from the background art, each driving force receiving portion 46 in this embodiment further includes a projecting portion 463c arranged on a guide surface 463. As shown in FIG. 14A and FIG. 14B, when measured along an axis of rotation L21, a distance between the guide surface 463 and a certain fixing surface (such as a surface, perpendicular to the axis of rotation L21, of one of a substrate 43, a base tray 42 and a connecting portion 41) of a driving force receiving member 4 or a certain fixing surface (such as the above surface CP) of a process cartridge is no longer a fixed value or a gradient value, but is changed across dimensional scales with projecting of the projecting portion 463c. As shown in FIG. 14B, with the surface CP as a reference surface, a point B1, located on an upstream side of the projecting portion 463c, of the guide surface 463, a point B2 at an interaction between the upstream side of the projecting portion 463c and the guide surface 463, and a highest point B3 of the projecting portion 463c are selected in a direction of rotation r, the point B1 is located on a most upstream side of the direction of rotation r, the point B3 is located on a most downstream side of the direction of rotation r, and when viewed along the axis of rotation L21, a distance between the point B1 and the surface CP is h3, a distance between the point B2 and the surface CP is h4, a distance between the point B3 and the surface CP is h5, and h3>h5>h4. In the mounting process of the process cartridge C, the projecting portion 463c abuts against a braking portion 203a, thereby reducing friction force between the receiving force receiving member 4 and the braking portion 203a and then allowing the driving force receiving portion 46 to engage with a force output member 203 more easily. Meanwhile, the engaging speed of a braking surface 465 and a coupling engaging portion 204b/208b in the braking portion 203a can further be reduced by the projecting portion 463c, so that noise generated during engagement of the driving force receiving member 4 and the braking portion 203a can be reduced, as well as the braking portion 203a can be prevented from being damaged.

In the mounting process of the process cartridge C, under the condition that a driving portion 180h and the braking portion 203a get close to each other, the guide surface 463 is used for separating a driving force output surface 180d from the coupling engaging portion 204b/208b in the braking portion 203a, the driving force output surface 180d is opposite to a driving surface 464, and the coupling engaging portion 204b/208b is opposite to a braking surface 465. In the operating process of the process cartridge C, the driving force output surface 180d applies a driving force to the driving surface 464, when the process cartridge C stops operating, the driving force output surface 180d no longer outputs the driving force to the driving surface 464, the coupling engaging portion 204b/208b applies a braking force to the braking surface 465 on a downstream side in a direction of rotation of the driving force receiving portion 46, and the driving force receiving member 4/driving force receiving portion 46 stops rotating.

### (Variant Structure)

In this variant structure, the projecting portion 463c projecting from the guide surface 463 is replaced with a recess 463d. When measured along the axis of rotation L21, a distance between the guide surface 463 and the certain fixing surface (such as the surface, perpendicular to the axis of rotation L21, of one of the substrate 43, the base tray 42 and the connecting portion 41) of the driving force receiving member 4 or the certain fixing surface (such as the above surface CP) of the process cartridge is no longer the fixed value or the gradient value, but is changed across dimensional scales with recessing of the recess 463d. As shown in FIG. 15A and FIG. 15B, with the surface CP as the reference surface, a point B1′, located on an upstream side of the recess 463d, of the guide surface 463, a lowest point B2′ of the recess 463d, and a point B3′, located on a downstream side of the recess 463d, of the guide surface 463 are selected in the direction of rotation r, the point B1′ is located on a most upstream side in the direction of rotation r, the point B3′ is located on a most downstream side in the direction of rotation r, when measured along the axis of rotation L21, a distance between the point B1′ and the surface CP is h3′, a distance between the point B2′ and the surface CP is h4′, a distance between the point B3′ and the surface CP is h5′, and h3′>h5′>h4′.

### Embodiment 8

As shown in FIG. 16A and FIG. 16B, the present invention differs from the background art in that each driving force receiving portion 46 in this embodiment further includes a flange portion 47 located on a radial outer side of at least one of a driving surface 464 and a braking surface 465. Preferably, the flange portion 47 extends outwards along a radial outer side of a guide surface 463, a surface, away from a substrate 43/base tray 42/connecting portion 41, of the flange portion 47 and the guide surface 463 are coplanar along an axis of rotation L21, and therefore at least one part of the guide surface 463 may further be appraised as located on the radial outer side of at least one of the driving surface 464 and the braking surface 465. As shown in FIGS. 16A and 16B, in the direction of rotation of the driving force receiving member 4, the starting position of the extension of the guide surface/contact surface 463a is flush with the first surface/driving surface 464.

When a process cartridge C with the driving force receiving portion 46/driving force receiving member 4 in this embodiment is mounted towards an image forming apparatus, a coupling engaging portion 204b/208b in a braking portion 203a can more easily reach a position where the coupling engaging portion 204b/208b is opposite to the braking surface 465 by engaging with the flange portion 47.

### Embodiment 9

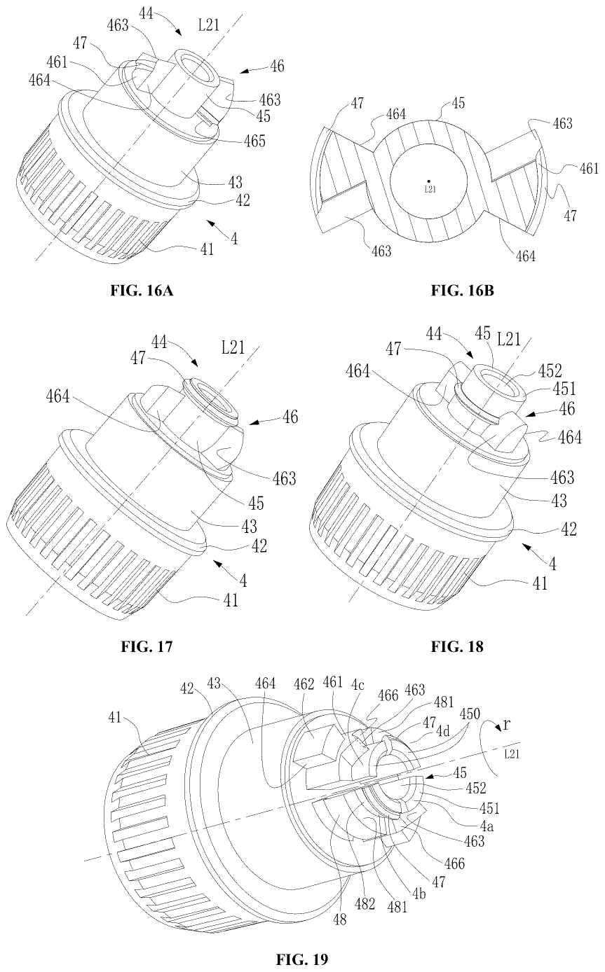

As shown in FIG. 17, in this embodiment, the above braking surface 465 is omitted. As shown in the figure, each driving force receiving portion 46 only has a driving surface 464 and a guide surface 463, and the guide surface 463 helically extends upward from a substrate 43. When a process cartridge C with the driving force receiving portion 46/driving force receiving member 4 is mounted to an image forming apparatus, the guide surface 463 may further be opposite to a coupling engaging portion 204b/208b of a braking portion 203a to achieve the same effect as a braking surface 465, so that the structure of the driving force receiving portion 46 is simplified, which is conducive to improving the production efficiency of the driving force receiving portion 46 and the driving force receiving member 4 including the driving force receiving portion 46.

Furthermore, a flange portion 47 is arranged on an outer circumference of a central pillar 45, or the flange portion 47 projects radially and outwards from the outer circumference of the central pillar 45. Preferably, the flange portion 47 is located at a free tail end 451 (end away from a connecting portion 41) of the central pillar 45 along an axis of rotation L21. As shown in FIG. 17, in the direction of the axis of rotation L21, the flange portion 47 is closer to the free tail end 451 of the central pillar 45 than the convex block 46. When viewed in a direction perpendicular to the axis of rotation L21, the driving force receiving portion 46 does not misalign with the flange portion 47, and a projecting dimension of the flange portion 47 does not go beyond a dimension of a base 461/driving surface 464/guide surface 463 in a radial direction of the driving force receiving member 4. When the driving force receiving member 4 with such structure engages with a force output member 203, the coupling engaging portion 204b/208b of the braking portion 203a hooks the flange portion 47 to achieve engagement of the driving force receiving member 4 and the force output member 203, which can effectively prevent the driving surface 464 of the driving force receiving member 4 from disengaging from a driving force output surface 180d of the force output member 203, thereby ensuring that the driving force receiving member 4 can stably receive a driving force from the force output member.

### (Variant Structure)

As shown in FIG. 18, in the variant structure, the flange portion 47 is arranged towards a position where the flange portion gets close to the connecting portion 41 (position away from the free tail end 451 of the central pillar) along the axis of rotation L21 relative to the free tail end 451 of the central pillar 45. As shown in FIG. 18, in the direction of the axis of rotation L21, the flange portion 47 is further away from the free tail end 451 of the central pillar 45 than a part of the convex block 46. The projecting dimension of the flange portion 47 does not go beyond the dimension of the base 461/driving surface 464/guide surface 463 in the radial direction of the driving force receiving member 4.

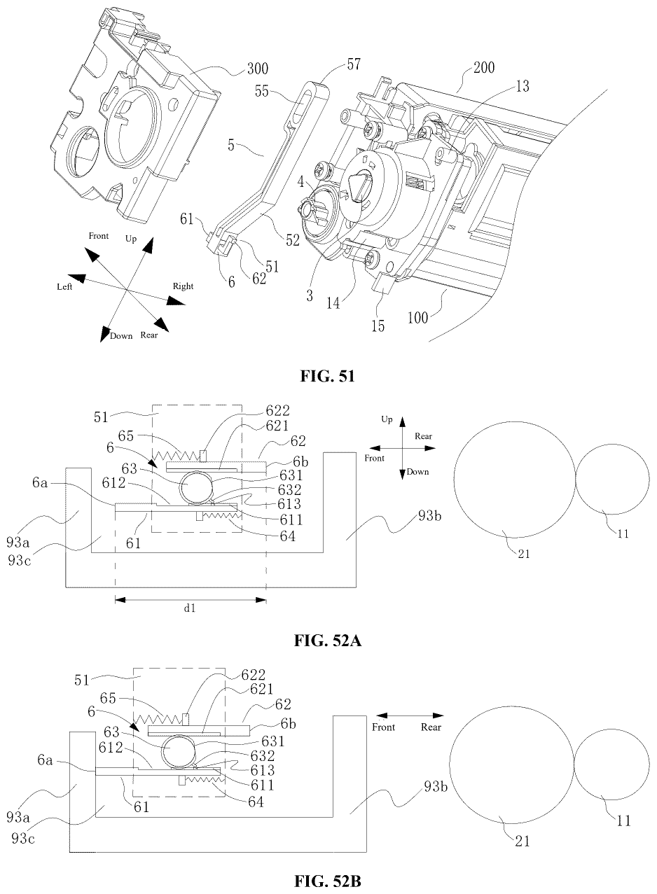

As shown in FIGS. 44A and 44B in the patent application in the background art, besides the above driving portion 180h and braking portion 203a, the force output member 203 further has a positioning pillar (positioning boss) 180i located in the driving portion 180h. When the driving force receiving member 4 engages with the force output member, as shown in FIG. 51 in the patent application in the background art, the positioning pillar 180i located on the force output member enters a positioning hole 452 of the central pillar 45, and the flange portion 47 will gradually get close to the braking portion 203a with the driving force receiving portion 46 till the coupling engaging portion 204b/208b hooks the flange portion 47, so that the flange portion 47 is arranged towards the position where the flange portion gets close to the connecting portion 41 to allow the coupling engaging portion 204b to more compactly engage with the flange portion 47, the driving surface 464 can be more effectively prevented from disengaging from the driving force output surface 180d, and the driving force receiving member 4 can more stably receive the driving force from the force output member accordingly.

### Embodiment 10

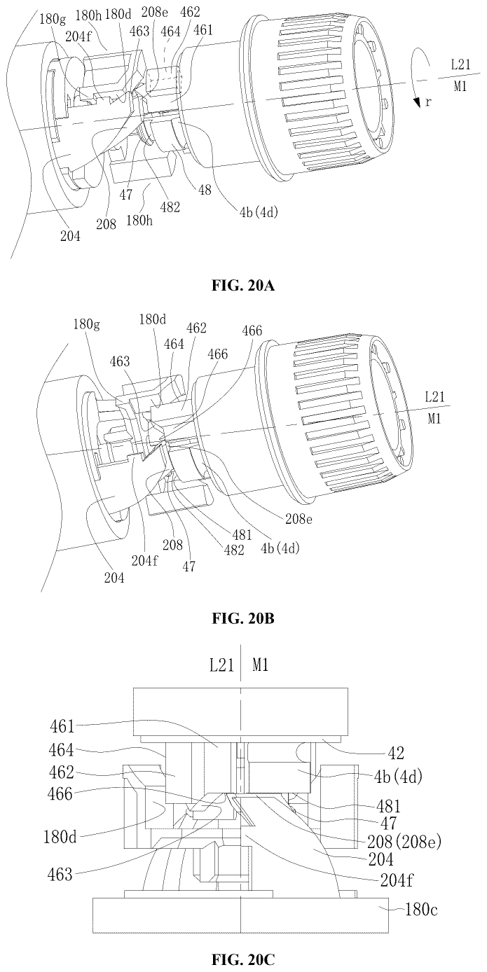

As shown in FIG. 19, FIG. 20A, FIG. 20B and FIG. 20C, a driving force receiving member 4 in this embodiment is arranged such that at least one part of an engaging portion 44 may move in a direction intersecting with an axis of rotation L21. As shown in the figures, when viewed from the engaging portion 44 to a connecting portion 41 along the axis of rotation L21 of the driving force receiving member, the driving force receiving member 4 can rotate around the axis of rotation L21 in a direction r (clockwise direction), and the engaging portion 44 is divided into a plurality of sub-engaging portions spaced from one another in the direction of rotation r.

An example of arranging four sub-engaging portions is taken. A first sub-engaging portion 4a, a second sub-engaging portion 4b, a third sub-engaging portion 4c and a fourth sub-engaging portion 4d are sequentially arranged in the direction of rotation r, wherein the first sub-engaging portion 4a and the third sub-engaging portion 4c are radially opposite, the second sub-engaging portion 4b and the fourth sub-engaging portion 4d are radially opposite, and a part of at least one of the second sub-engaging portion 4b and the fourth sub-engaging portion 4d is arranged to be capable of moving relative to the first sub-engaging portion 4a and the third sub-engaging portion 4c. Each sub-engaging portion includes a part of a central pillar 45. The first sub-engaging portion 4a and the third sub-engaging portion 4c may also be referred to as fixed engaging portions, the second sub-engaging portion 4b and the fourth sub-engaging portion 4d may also be referred to as movable engaging portions, and the movable engaging portions can move relative to the fixed engaging portions.

Preferably, structures of the first sub-engaging portion 4a and the third sub-engaging portion 4c are the same, and structures of the second sub-engaging portion 4b and the fourth sub-engaging portion 4d are the same. The fixed engaging portions and the movable engaging portions are formed by extending from the connecting portion 41/base tray 42/substrate 43, wherein the movable engaging portions are arranged as cantilevers formed by extending from the connecting portion 41/base tray 42/substrate 43, for example, dimensions of joints of the movable engaging portions and the connecting portion 41/base tray 42/substrate 43 are less than those of joints of the fixed engaging portions and the connecting portion 41/base tray 42/substrate 43 in a radial direction of the driving force receiving member 4. More preferably, the fixed engaging portions and the movable engaging portions are formed by extending from a side, away from the connecting portion 41, of the substrate 43.

Each fixed engaging portion includes a base plate 450, a base 461 and a convex block 462, the base plate 450, the base 461 and the convex block 462 are sequentially arranged and gradually away from the axis of rotation L21 in a radial direction perpendicular to the axis of rotation L21, the base plate 450 is a part of the central pillar 45, a guide surface 463 is arranged on the base 461, a driving surface 464 is arranged on the convex block 462, the driving surface 464 is located on an upstream side of the guide surface 463 in the direction of rotation r, and an abutting surface 466 is further formed on the base 461 along the axis of rotation L21. Each movable engaging portion includes a base plate 450, and a flange portion 47 and a pressing portion 48 which are arranged on the base plate 450, the pressing portion 48 extends from the base plate 450 in a direction away from the axis of rotation L21, and a pressing surface 481 is formed at an end away from the connecting portion 41. The flange portion 47 in this embodiment also has the effect of preventing the driving force receiving member 4 from disengaging from a force output member 203, so that the flange portion 47 may be appraised as an embodiment of an anti-disengaging portion, and specifically, the flange portion 47 in this embodiment is arranged to be formed by projecting outwards in a radial direction of a free tail end (free tail end of the central pillar) 451 of the base plate 450.

Preferably, when viewed in the direction perpendicular to the axis of rotation L21, the abutting surface 466 is basically flush with the pressing surface 481 and perpendicular to the axis of rotation L21, furthermore, the abutting surface 466 and the pressing surface 481 are both separated from the free tail end 451 of the central pillar along the axis of rotation L21, or the abutting surface 466 and the pressing surface 481 are closer to the connecting portion 41 than the free tail end 451 of the central pillar, and a limiting space 482 is formed between the pressing surface 481 and the free tail end 451 of the central pillar.

In order to more clearly describe the engaging process of the driving force receiving member 4 and the force output member 203, a part of the force output member 203 in this embodiment and the following embodiment is cut off, so that a driving portion 180h and a braking portion 203a are both exposed.

As shown in FIG. 20A, FIG. 20B and FIG. 20C, when the driving force receiving member 4 gradually gets close to the force output member 203 along the axis of rotation L21 with a process cartridge C, the guide surface 463 starts to abut against an inward projection 208e of a second braking engagement member 208, and as the process cartridge C continues to be mounted, the second braking engagement member 208 starts to be guided by the guide surface 463 in the direction of rotation r, so that a first braking engagement member 204 will also move in the direction of rotation r, that is, the whole braking portion 203a is gradually away from the driving portion 180h in the direction of rotation r, meanwhile, an upper projecting portion 204f and a lower projecting portion 180g are no longer opposite, but are gradually staggered along the axis of rotation L21, the whole braking portion 203a further retracts (retracted state) into a cylindrical portion 180c, and thus the driving portion 180h cannot be driven by the braking portion 203a to retract into the cylindrical portion 180c.

As the driving portion 180h is separated from the braking portion 203a, the convex block 462, in the direction of rotation r, migrates into a position between the driving portion 180h and the braking portion 203a. In this configuration, a driving force output surface 180d is located opposite to the driving surface 464. The braking portion 203a (second braking engagement member 208) at least abuts against the abutting surface 466 to be kept in the retracted state, and the driving force receiving member 4 engages with the force output member 203; and when the driving portion 180h starts to rotate, the driving force output surface 180d outputs a driving force to the driving surface 464, and the driving force receiving member 4 starts to rotate around the axis of rotation L21.

It should be noted that during engagement of the driving force receiving member 4 with the force output member 203, if the braking portion 203a (second braking engagement member 208) slides over the abutting surface 466 after being guided by the guide surface 463 to reach a position where the braking portion is opposite to the pressing surface 481, the braking portion 203a (second braking engagement member 208) can still be kept in the retracted state, that is, the pressing surface 481 has the effect of preventing the braking portion 203a (second braking engagement member 208) from extending from the retracted state and restoring to an initial state (extended state).

In this embodiment, the braking portion 203a is kept in the retracted state, in the operating process of the process cartridge, the braking portion 203a no longer outputs a braking force to the driving force receiving member 4, and in the process where the process cartridge is taken out, a friction force between the braking portion 203a and the driving force receiving member 4 can be reduced. Furthermore, during engagement of the driving force receiving member 4 with the force output member 203, the movable engaging portion is pressed by the braking portion 203a (second braking engagement member 208) to deform in a direction close to the axis of rotation L21 till the inward projection 208e passes over the flange portion 47 to enter the limiting space 482, and a positioning pillar 180i of the driving portion enters a positioning hole 452 of the central pillar 45, then the movable engaging portion is reset, and the inward projection 208e engages (is clamped) with the flange portion 47. Meanwhile, the positioning pillar 180i further pushes/extrudes the central pillar 45/base plate 450 in the direction away from the axis of rotation L21, the first braking engagement member 204 is stably positioned in the driving force receiving member 4 along an axis M1, the first braking engagement member 204 compactly engages with the flange portion 47, potential axial movement of the force output member 203 is restricted, and the force output member 203 cannot retract in the direction away from the driving force receiving member 4, but disengages from the driving force receiving member 4. It can be shown that the movable engaging portion in this embodiment can swing between being close to the axis of rotation L21 and being away from the axis of rotation L21 relative to the fixed engaging portion, meanwhile, the inward projection 208e is further kept to abut against the abutting surface 466, and the force output member 203 and the driving force receiving member 4 can be kept to stably engage with each other.

### Embodiment 11

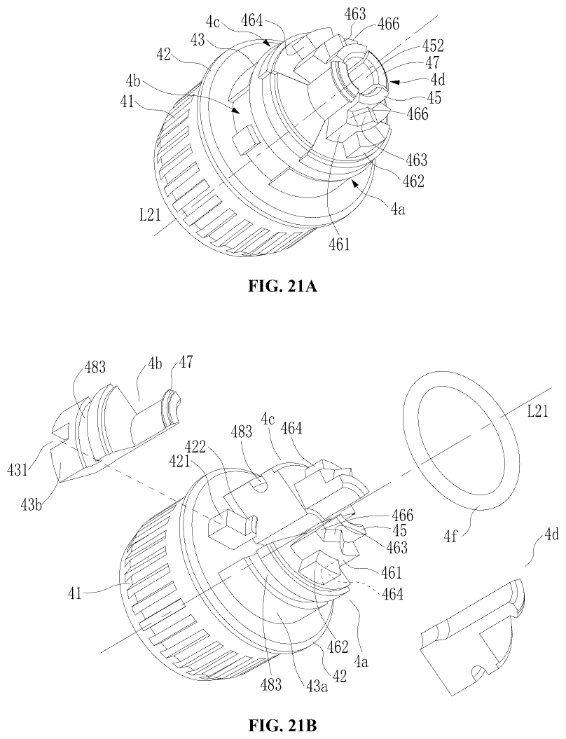

As shown in FIG. 21A and FIG. 21B, a driving force receiving member 4 in this embodiment still includes a fixed engaging portion and a movable engaging portion. This embodiment differs from Embodiment 10 in that the movement manner of the movable engaging portion in this embodiment is arranged as sliding, specifically, the movable engaging portion can slide in a direction intersecting with an axis of rotation L21 relative to the fixed engaging portion, and preferably, the sliding direction of the movable engaging portion is perpendicular to the axis of rotation L21.

As shown in the figures, a substrate 43 in this embodiment is also cut, that is, the fixed engaging portion and the movable engaging portion in this embodiment further include a part of the substrate 43. In order to facilitate the understanding, the substrate located in the fixed engaging portion is referred to as a first substrate 43a, the substrate located in the movable engaging portion is referred to as a second substrate 43b, a base 461 and a convex block 462 are both located above (direction away from a connecting portion 41) the first substrate 43a, a part of a central pillar 45 extends upward from the second substrate 43b, a flange portion 47 is located at a free tail end of the central pillar 45, the second substrate 43b further has a guided portion 431, a base tray 42 has a guide 421, and the movable engaging portion can slide in the direction intersecting with the axis of rotation L21 through the cooperation between the guide 421 and the guided portion 431. Preferably, the guided portion 431 is arranged as a guided recess, the guide 421 is guided as a guiding projection, and at least one of the guided recess 431 and the guiding projection further has a restricting projection 422 for restricting the movable engaging portion from moving close to the axis of rotation L21.

In some embodiments, positions of the guided recess and the guiding projection further may be exchanged.

In some embodiments, an anti-disengaging portion is arranged to prevent the movable engaging portion from moving away from the axis of rotation L21, the anti-disengaging portion and a restricting projection 422 jointly restrict the movement range of the movable engaging portion in a radial direction of the driving force receiving member 4, on one hand, the driving force receiving member 4 more stably engages with a force output member 203, and on the other hand, the driving force receiving member 4 can more easily disengages from the force output member 203. As shown in FIG. 21B, the substrate 43 has a mounting portion 483 used for engaging with the anti-disengaging portion 4f, preferably, the anti-disengaging portion 4f is an elastic member sleeving an outer surface of the substrate 43, the mounting portion 483 is a mounting groove formed in the substrate 43, the anti-disengaging portion 4f is mounted in the mounting groove 483, when the movable engaging portion is propelled by an acting force (such as a pushing force applied by a following pushing member) to move away from the axis of rotation L21, the movable engaging portion propels the elastic member to elastically deform, and when the acting force is withdrawn, the elastic member pushes the movable engaging portion to move close to the axis of rotation L21.

In some embodiments, the driving force receiving member 4 is further provided with the pushing member for pushing the movable engaging portion away from the axis of rotation L21, preferably, the pushing member is arranged as the elastic member with elasticity, when the driving force receiving member 4 has engaged with the force output member 203, a positioning pillar 180i of a driving portion enters a positioning hole 452 of the central pillar 45, the pushing member elastically deforms to generate the pushing force away from the axis of rotation L21, under the action of the pushing force of the pushing member, the flange portion 47 can more compactly engage with an inward projection 208e of a second braking engagement member, potential axial movement of the force output member 203 is stopped, and the force output member 203 cannot retract away from the driving force receiving member 4, but disengages from the driving force receiving member 4. When a process cartridge needs to be taken out, as the driving force receiving member 4 is pulled away from the force output member 203, the inward projection 208e extrudes the flange portion 47 to overcome the pushing force of the pushing member, the movable engaging portion moves close to the axis of rotation L21 till the inward projection 208e disengages from the flange portion 47, and then the pushing member propels the movable engaging portion to move away from the axis of rotation L21 again.

Similar to Embodiment 10, the positioning pillar 180i entering the positioning hole 452 also can achieve the effect of extruding/pushing the movable engaging portion away from the axis of rotation L21, so that the flange portion 47 can also compactly engage with the inward projection 208e even when there is no elastic member, and it can be shown that the positioning pillar 180i may also be appraised as a type of the pushing member.

### Embodiment 12

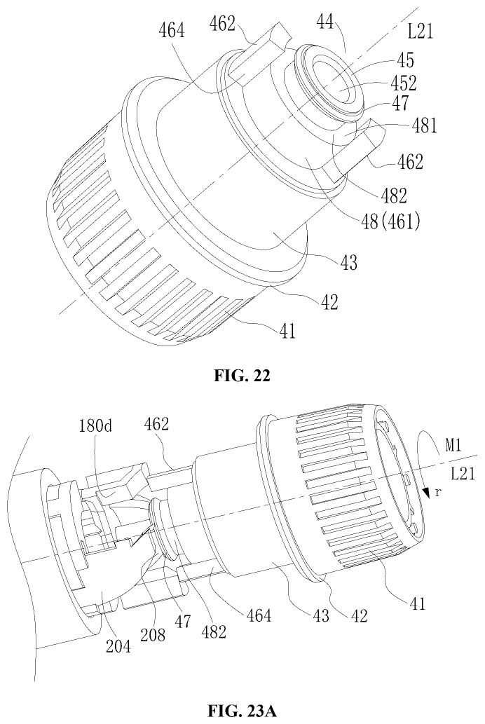

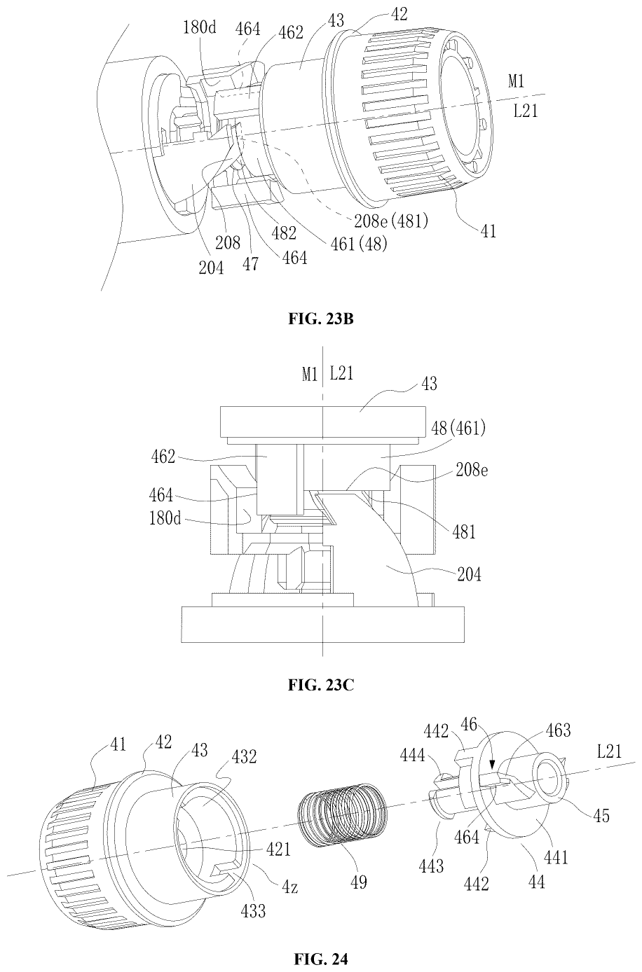

As shown in FIG. 22, FIG. 23A, FIG. 23B and FIG. 23C, an engaging portion 44 includes a central pillar 45, a base 461 and a convex block 462. The central pillar 45, the base 461 and the convex block 462 are sequentially located away from an axis of rotation L21 in a radial direction perpendicular to the axis of rotation L21 of a driving force receiving member. In this embodiment, the base 461 extends around an outer circumferential surface of the central pillar 45, that is, enclosing the central pillar 45, so that the base 461 may further be appraised as a pressing portion 48, and a tail end surface of the base 461 is a pressing surface 481. The convex block 462 extends further away from a connecting portion 41 than the base 461 along the axis of rotation L21, that is, the convex block 462 exceeds the pressing surface 481, and meanwhile a driving surface 464 for receiving a driving force is further formed on the convex block 462.

Furthermore, the engaging portion 44 further includes an anti-disengaging portion arranged on the central pillar 45, preferably, the anti-disengaging portion is a flange portion 47 arranged at a free tail end of the central pillar 45, and a limiting space 482 is formed between the flange portion 47 and the pressing surface 481 along the axis of rotation L21.

As shown in FIG. 23A, before the driving force receiving member 4 engages with a force output member 203, a driving portion 180h is separated from a braking portion 203a in a direction of rotation r, the engaging portion 44 does not need to have a guide surface for separating the braking portion 203a from the driving portion 180h, and therefore the structure of the engaging portion 44 can be simplified.

When the driving force receiving member 4 engages with the force output member 203, the braking portion 203a (inward projection 208e of second braking engagement member) is firstly pressed by the flange portion 47 to retract. As a process cartridge C is mounted, the inward projection 208e of the second braking engagement member extrudes the flange portion 47 mutually and finally passes over the flange portion 47 to enter the limiting space 482, similarly, a positioning pillar 180i of the driving portion enters a positioning hole 452 of the central pillar 45, the braking portion 203a (inward projection 208e of second braking engagement member) is pressed by the pressing surface 481 and cannot extend out, the inward projection 208e engages with the flange portion 47, potential axial movement of the force output member 203 is stopped, and the force output member 203 cannot retract away from the driving force receiving member 4, but becomes disengaged from the driving force receiving member 4. The convex block 462 enters a position between the driving portion 180h and the braking portion 203a, a driving force output surface 180d is opposite to the driving surface 464, and the driving force receiving member 4 has engaged with the force output member 203. As the driving portion 180h starts to rotate in the direction r, the driving force output surface 180d outputs the driving force to the driving surface 464, the driving force receiving member 4 also rotates in the direction r, and the braking portion 203a will no longer output a braking force to the driving force receiving member 4.

### Embodiment 13

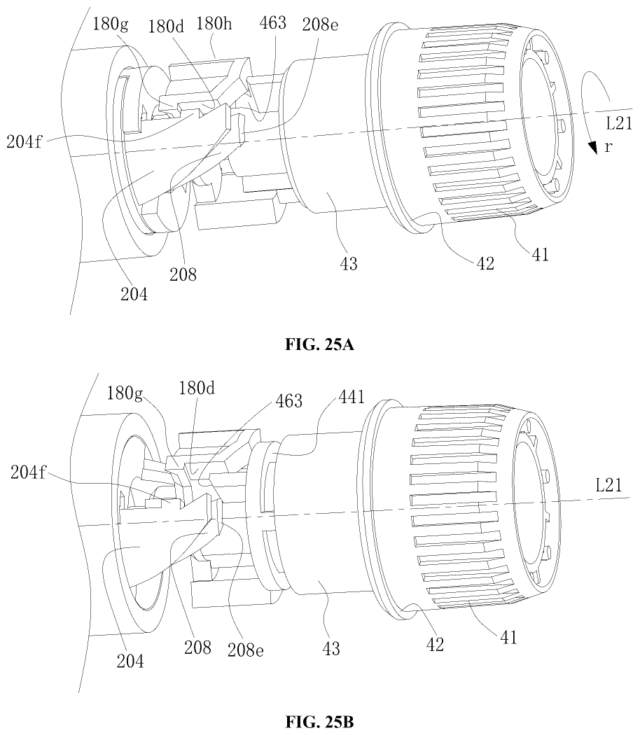

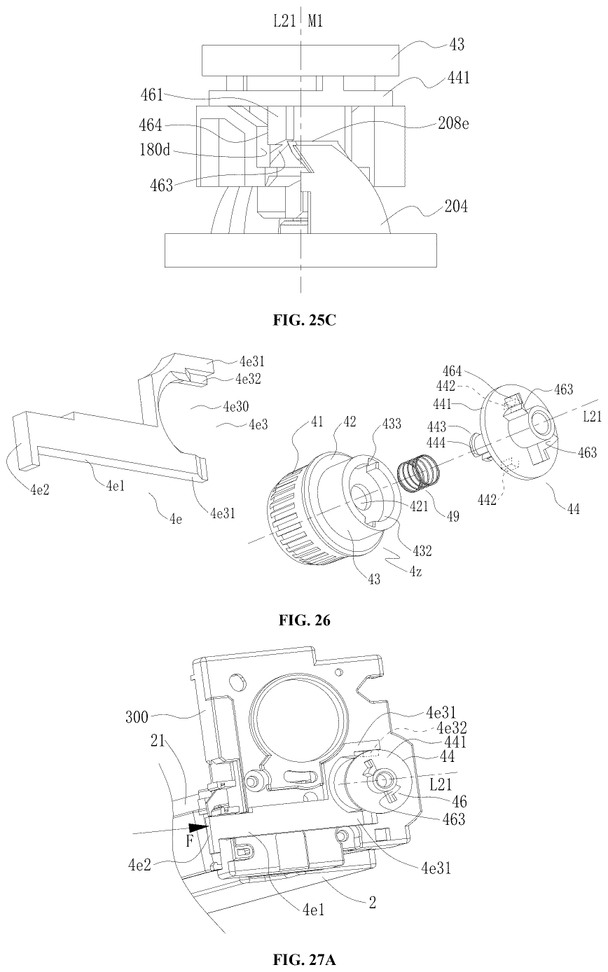

As shown in FIG. 24, FIG. 25A, FIG. 25B and FIG. 25C, in this embodiment, an engaging portion 44 is arranged to be capable of moving relative to a second rotating member/photosensitive drum 21 or a connecting portion 41 along an axis of rotation L21, that is, the engaging portion 44 can move between a position (retracted state of engaging portion) where the engaging portion gets close to the connecting portion 41 and a position (extended state of engaging portion) where it moves away from the connecting portion 41.

As shown in the figures, the engaging portion 44 and a substrate 43 are formed in a split manner, a driving force receiving member 4 further includes a movable cavity 432 formed inside the substrate 43 and a holding member 49 for keeping the engaging portion 44 at a position where the engaging portion moves away from the second rotating member/photosensitive drum 21 or the connecting portion 41, and the holding member 49 is preferably arranged as a compression spring. At this moment, the driving force receiving member 4 may be split into an engaged portion 4z including the connecting portion 41, a base tray 42 and the substrate 43, the engaging portion 44, and the holding member 49 located between the engaged portion and the engaging portion, wherein the engaging portion and the engaged portion 4z are formed in a split manner. The engaged portion 4z is used for transmitting a driving force received by the engaging portion 44, and the holding member 49 is used for pushing the engaging portion 44 away from the engaged portion 4z along the axis of rotation L21. The engaging portion 44 includes a bottom plate 441, a central pillar 45 and driving force receiving portions 46 which extend from one side of the bottom plate 441, and a driving force transmitting portion 442 extending from the other side of the bottom plate 441. Along the axis of rotation L21, the central pillar 45 and each driving force receiving portion 46 extends away from the connecting portion 41, and the driving force transmitting portion 442 extends close to the connecting portion 41.

Each driving force receiving portion 46 still has a guide surface 463 and a driving surface 464, wherein when the driving force receiving member 4 engages with a force output member 203, the guide surface 463 is used for propelling a braking portion 203a to rotate relative to a driving portion 180h so that the braking portion 203a and the driving portion 180h can be separated from each other, and the driving surface 464 is used for receiving a driving force. Each driving force receiving portion 46 in this embodiment does not have a braking surface for receiving a braking force.

The driving force transmitting portion 442 is used for engaging with the substrate 43 to transmit the driving force received by each driving force receiving portion 46 to the substrate 43, so as to drive the rotating member 21 connected with the connecting portion 41 to rotate. In some embodiments, the driving force transmitting portion 442 is provided with a projection extending from the bottom plate 441 in the direction close to the connecting portion 41 along the axis of rotation L21, correspondingly, a groove 433 capable of fitting with the projection is formed in a side wall of the movable cavity 432, or positions of the projection and the groove are exchanged. The bottom tray 42 is formed as a bottom wall of the movable cavity 432, one end of the compression spring 49 abuts against the base tray 42, and the other end thereof abuts against a surface of a side, facing the connecting portion 41, of the bottom plate 441.

Furthermore, the engaging portion 44 further includes a guiding engagement pillar 443 arranged on the same side as the driving force transmitting portion 442, correspondingly, a guiding hole 421 fitting with the guiding engagement pillar 443 is formed in the base tray 42, the guiding engagement pillar 443 is arranged as a cantilever capable of elastically deforming in a direction intersecting with the axis of rotation L21, and a clamping projection 444 is arranged at a tail end of the cantilever. When the engaging portion 44 is mounted, the guiding engagement pillar 443 is extruded to elastically deform, the clamping projection 444 is clamped with the guiding hole 421, and the engaging portion 44 can stably engage with the connecting portion 41/substrate 43. When the engaging portion 44 moves along the axis of rotation L21, it can be ensured that a movement trajectory of the engaging portion 44 does not deviate due to the cooperation between the guiding engagement pillar 443 and the guiding hole 421.

When the driving force receiving member 4 engages with the force output member 203, the guide surface 463 force the braking portion 203a to rotate in the direction of rotation r to be separated from the driving portion 180h, then the driving surface 464is opposite to a driving force output surface 180d, the driving force receiving member 4 engages with the force output member 203, and the driving force receiving member 4 can receive the driving force output by the driving portion 180h.

In this embodiment, the braking portion 203a will further gradually retract towards a retracted state while being pushed and guided by the guide surface 463, when the driving surface 464 is opposite to the driving force output surface 180d, the braking portion 203a can either be in a state of being pressed by the guide surface 463, or in an extended state where it is no longer pressed by the guide surface 463, output of the driving force to the driving surface 464 by the driving force output surface 180d cannot be influenced no matter which state the braking portion 203a is in, and the braking portion 203s at this moment may be considered disabled since it cannot apply the braking force to the driving force receiving member 4.

Different from the above embodiment, the engaging portion 44 in this embodiment is arranged to be capable of extending and retracting. When the driving force receiving member 4 engages with the force output member 203, the braking portion 203a is pressed by the guide surface 463, the guide surface 463 is also pressed by the braking portion 203a in turn, the engaging portion 44 retracts close to the connecting portion 41/photosensitive drum 21, and the compression spring 49 will also elastically deform. Therefore, each driving force receiving portion 46 will be pushed by the compression spring 49 towards the force output member 203, that is, each driving force receiving portion 46 can move with the driving portion 180h/braking portion 203a, and finally the driving force receiving member 4 and the force output member 203 can be kept in stable and compact engagement similarly.

### Embodiment 14

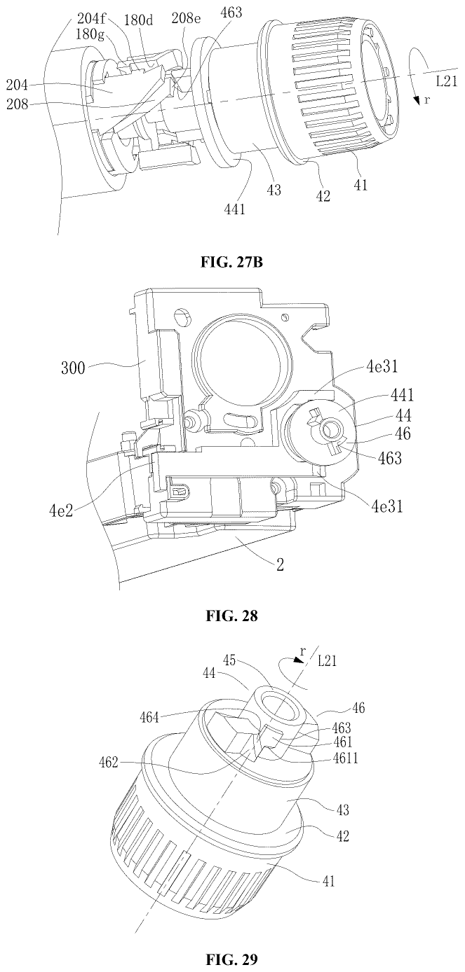

As shown in FIG. 26, FIG. 27A, FIG. 27B and FIG. 28, the engaging portion 44 in Embodiment 13 can move with the driving portion 180h/braking portion 203a under the action of a pushing force of the compression spring 49, so as to ensure that the driving force receiving member 4 and the force output member 203 are kept in stable and compact engagement, that is, the engaging portion 44 can actively move with the driving portion 180h/braking portion 203a. The engaging portion 44 in this embodiment will be arranged to passively move with the driving portion 180h/braking portion 203a.

As shown in the figures, the holding member 49 is preferably arranged as a tension spring, and the tension spring 49 is used for keeping the engaging portion 44 in a retracted state of the engaging portion. The driving force receiving member 4 further includes an acting member 4e, the acting member 4e is movably mounted on a driving end cover 300/non-driving end cover 400/first unit casing 1/second unit casing 2, and the acting member 4e is used for propelling the engaging portion 44 to move from the retracted state to an extended state when receiving an external acting force.

The structure of the engaging portion 44 and the engaging structure of the engagement portion 44 and a substrate 43 are the same as those in Embodiment 13, and the acting member 4e and its movement process will be described in detail here.

The acting member 4e is preferably an acting rod movably arranged in a process cartridge, the acting rod 4e includes an intermediate rod 4e1, and a force bearing portion 4e2 and a pushing portion 4e3 which are located at two ends of the intermediate rod 4e1 respectively. The pushing portion 4e3 is forked, including two pushing rods 4e31 connected with the intermediate rod 4e1. At least one pushing rod 4e31 has a pushing force 4e32 inclined relative to an axis of rotation L21, and an accommodating space 4e30 is formed between the two pushing rods 4e31.

FIG. 27A shows an example that the acting rod 4e is mounted on the driving end cover 300. Before the driving force receiving member 4 engages with the force output member 203, the engaging portion 44 is in the retracted state, and the pushing surface 4e32 is opposite to a surface of a side, facing a connecting portion 41, of a bottom plate 441. As the force bearing portion 4e2 receives the external acting force F, the pushing surface 4e32 starts to push the bottom plate 441, and then the engaging portion 44 gradually moves towards the extended state of the engaging portion. As shown in FIG. 27B, a guide surface 463 arranged in the engaging portion 44 propels a braking portion 203a to be away from a driving portion 180h in a direction of rotation r, and then a driving surface 464 is opposite to a driving force output surface 180d. As described above, the force output member 203 can move towards a flange portion 180a (direction away from the driving force receiving member 4) along an axis M1. When the driving force receiving member 4 engages with the force output member 203, and if the force output member 203 is pressed to move towards the flange portion 180a, the engaging portion 44 will also passively move with the force output member 203 under a pushing action of the pushing rods 4e31 till the force output member 203 no longer moves towards the flange portion 180a along the axis M1, and finally the engaging portion 44 and the force output member 203 can be kept in stable and compact engagement.

Preferably, the driving force receiving member 4 further includes a reset member (not shown) for propelling the acting rod 4e to be reset, for example, the reset member is a compression spring or tension spring mounted between the acting rod 4e and the process cartridge casing/end cover. As shown in FIG. 28, the engaging portion 44 is in the extended state of the engaging portion, the reset member does not elastically deform, when the external acting force F applied to the force bearing portion 4e2 is withdrawn, the reset member releases a reset force, the acting rod 4e is reset, and meanwhile, the tension spring 49 pulls the engaging portion 44 back to the retracted state from the extended state.

In some embodiments, the external acting force F may come from a door cover of an image forming apparatus, and when closed, the door cover applies the acting force to the force bearing portion 4e2.

In some embodiments, the external acting force may further come from an inner wall of the image forming apparatus, the image forming apparatus with a drawer type accommodating portion is available, a process cartridge is mounted in the drawer type accommodating portion, when the process cartridge needs to be mounted or taken out, the door cover is opened, the drawer type accommodating portion firstly ascends by a certain distance with opening of the door cover, and then is pulled out, after the process cartridge is mounted or taken out, the drawer type accommodating portion is pushed into a preset position in the image forming apparatus, and finally, when the door cover is closed, the drawer type accommodating portion descends by a certain distance and then gets close to a transfer apparatus arranged in the image forming apparatus. As for this image forming apparatus, the external acting force may be generated by mutual interference between the inner wall of the image forming apparatus and the force bearing portion 4e2 when the drawer type accommodating portion is pushed into the image forming apparatus, or generated by mutual interference between the transfer apparatus and the force bearing portion 4e2 when the drawer type accommodating portion descends during closing of the door cover. In some embodiments, during closing of the door cover, the drawer type accommodating portion does not descend, but rather the transfer apparatus opposite to the drawer type accommodating portion ascends to come into close proximity with it, and the external acting force is generated by mutual interference between the transfer apparatus and the force bearing portion 4e2 when the transfer apparatus ascends.

### Embodiment 15

The embodiment in which a driving force output surface 180d arranged in a driving portion 180h is used for applying a driving force to a driving force receiving member 4 is described above, however, when a force output member 203 operates, a braking portion 203a will also rotate with the driving portion 180h, so that the braking portion 203a may also serve as a component for applying the driving force to the driving force receiving member 4. The embodiment in which the braking portion 203a engages with the driving force receiving member 4 to transmit the driving force will continue to be described below.

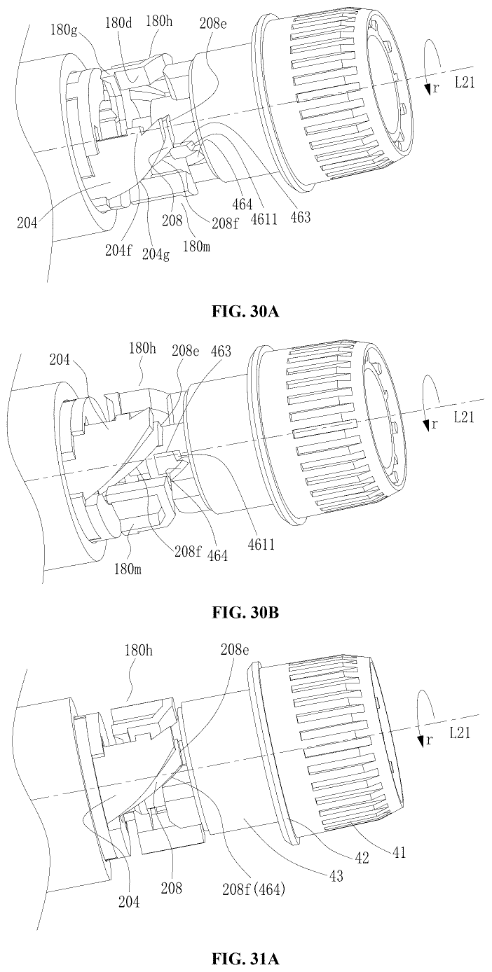

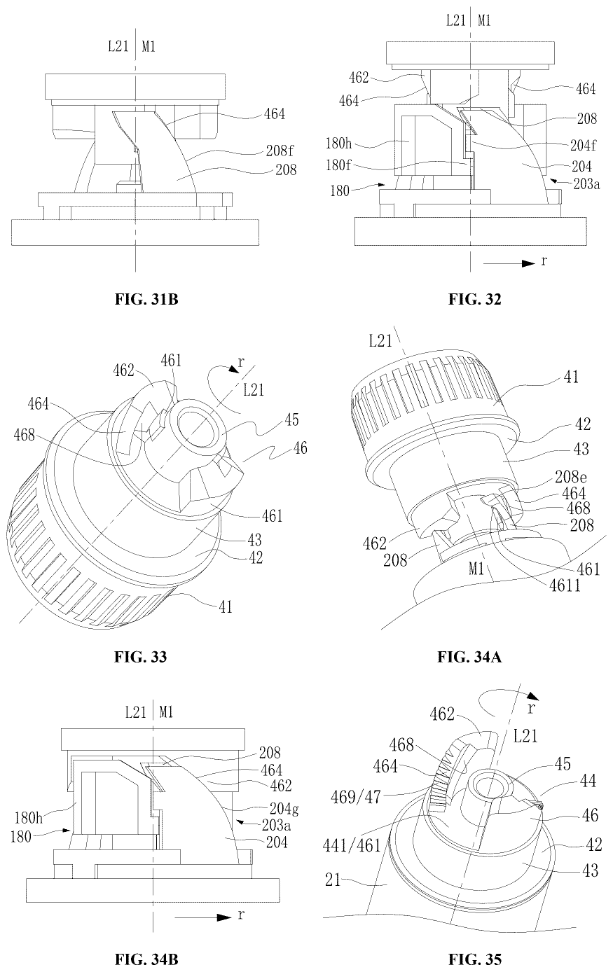

As shown in FIG. 29, FIG. 30A, FIG. 30B, FIG. 31A, FIG. 31B, and FIG. 32, each driving force receiving portion 46 stills include a base 461 and a convex block 462 which are located on a radial outer side of a central pillar 45, wherein the convex block 462 is farther away from an axis of rotation L21 than the base 461, the convex block 462 has a driving surface 464 for receiving the driving force, the driving surface 464 may engage with a first braking engagement member 204 or a second braking engagement member 208, and engagement of the driving surface 464 with the second braking engagement member 208 will be described in this embodiment.

As described above, the second braking engagement member 208 is located on an inner side of the first braking engagement member 204 in a radial direction of the force output member 203, and preferably, the driving surface 464 will be opposite to the second braking engagement member 208 in the direction of rotation r.

As shown in the figures, the second braking engagement member 208 has an inner output surface 208f located on a downstream side in the direction of rotation r, the inner output surface 208f helically ascends in a direction against the direction of rotation r relative to the axis of rotation L21, and preferably, the driving surface 464 is arranged as a helical surface fitting with the inner output surface 208f.

In order to more clearly describe the engagement state of the second braking engagement member 208 with the driving force receiving member 4, the driving portion 180h and the first braking engagement member 204 are hidden in FIG. 31B.

Before the driving force receiving member 4 engages with the force output member 203, the driving portion 180h is away from the braking portion 203a in the direction of rotation r. When the driving force receiving member 4 engages with the force output member 203, and if the braking portion 203a abuts against the convex block 462, the braking portion 203a will be pressed to retract; with rotation of the force output member 203, when the driving portion 180h abuts against the braking portion 203a, the driving portion 180h and the braking portion 203a rotate in the direction r together till the convex block 462 no longer abuts against the braking portion 203a and the driving portion 180h, and the braking portion 203a and the driving portion 180h will extend out. As shown in FIG. 31B, the inner output surface 208f abuts against the driving surface 464, the second braking engagement member 208 starts to output the driving force to the driving force receiving member 4, and the braking portion 203a no longer applies a braking force to the driving force receiving member 4.

As shown in FIG. 32, before the driving force receiving member 4 engages with the force output member 203, the driving portion 180h and the braking portion 203a get close to each other in the direction of rotation r, as a process cartridge C is mounted, the convex block 462 extrudes the driving portion 180h and/or the braking portion 203a, and the driving portion 180h and/or the braking portion 203a retract/retracts. With rotation of the driving portion 180h, the driving portion 180h will push the braking portion 203a to rotate together, when the driving portion 180h and/or the braking portion 203a no longer are/is extruded by the convex block 462, a first spring/drum drive coupling spring 210 and/or a second spring/braking engagement spring 211 arranged in the force output member 203 release/releases elastic force to allow the driving portion 180h and/or the braking portion 203a to extend out, then the inner output surface 208f abuts against the driving surface 464, the second braking engagement member 208 starts to output the driving force to the driving force receiving member 4, and the braking portion 203a no longer applies the braking force to the driving force receiving member 4.

Furthermore, the base 461 further has a holding surface 4611, the holding surface 4611 faces a connecting portion 41 along the axis of rotation L21, the holding surface 4611 is closer to the axis of rotation L21 than the driving surface 464 in a radial direction perpendicular to the axis of rotation L21, when the inner output surface 208f abuts against the driving surface 464, an inward projection 208e of the second braking engagement member abuts against the holding surface 4611, the braking portion 203a may be kept in stable and compact engagement with the driving force receiving member 4, and therefore the holding surface 4611 may be appraised as an embodiment of an anti-disengaging portion 47.

Furthermore, the base 461 further includes a guide surface 463 adjacent to the holding surface 4611. As shown in FIG. 30A and FIG. 30B, when the driving force receiving member 4 engages with the force output member 203, the guide surface 463 abuts against the braking portion 203a to guide the inward projection 208e to a position where the inward projection engages with the holding surface 4611, and guide an outer output surface 204g/inner output surface 208f to a position where the outer output surface/inner output surface is opposite to the driving surface 464.

### Embodiment 16

Different from Embodiment 15, a driving force receiving member 4 in this embodiment is driven by a first braking engagement member 204, the first braking engagement member 204 has an outer output surface 204g located on a downstream side in a direction of rotation r, and the outer output surface 204g is also arranged to helically extend upward in a direction against the direction of rotation r.

As shown in FIG. 33, FIG. 34A, and FIG. 34B, each driving force receiving portion 46 in this embodiment includes a base 461 and a convex block 462 which are located on a radial outer side of a central pillar 45, the convex block 462 is farther away from an axis of rotation L21 than the base 461, a driving surface 464 capable of fitting with the outer output surface 204g is arranged on the convex block 462, a receding portion 468 is further formed between the driving surface 464 and the central pillar 45 in a radial direction perpendicular to the axis of rotation L21, and specifically, the receding portion 468 is formed on the convex block 462.

As shown in FIG. 34A, in order to more clearly describe functions of the receding portion 468, the first braking engagement member 204 is hidden in the figure. The engaging process of an engaging portion 44/driving force receiving member 4 with a force output member 203 in this embodiment is the same as that in Embodiment 15, which is not repeated here. However, when the driving force receiving member 4 has engaged with the force output member 203, at least one part of a second braking engagement member 208 enters the receding portion 468. As shown in FIG. 34B, the outer output surface 204g abuts against the driving surface 464, the first braking engagement member 204 starts to output a driving force to the driving force receiving member 4, and a braking portion 203a will no longer apply a braking force to the driving force receiving member 4.

Preferably, the base 461 in this embodiment may also have the above holding surface 4611 or a rough surface or a surface with additional elastic rubber, an inward projection 208e of the second braking engagement member 208 entering the receding portion 468 further engages with the holding surface 4611/rough surface/surface with the additional elastic rubber while the outer output surface 204g abuts against the driving surface 464, and therefore the braking portion 203a may be kept in stable and compact engagement with the driving force receiving member 4.

Optionally, in the absence of the holding surface 4611 in the engaging portion 44, it is permissible to exclude the base 461 which constitutes the holding surface 4611. Nevertheless, a bottom plate 441 located between the central pillar 45 and the convex block 462 may be appraised as fulfilling the role of the base 461 in the radial direction of the driving force receiving member 4. The structure of the engaging portion 44 may be simplified.

As mentioned above, the holding surface 4611 may be used to prevent the driving force receiving member 4 from disengaging from the force output member 203. Therefore, the holding surface 4611 or the rough surface or the surface with the additional elastic rubber may also be appraised as one embodiment of the anti-disengagement portion 47. In various embodiments involving the anti-disengagement portion 47, a person skilled in the art may make a selection according to design requirements to ensure stable and tight engagement of the driving force receiving member 4 with the force output member 203.

### Embodiment 17

Similar to Embodiment 13 and Embodiment 14, in this embodiment, an engaging portion 44 and an engaged portion 4z are also formed as separated members, which allows the engaging portion 44 and the engaged portion 4z to be made of different materials, for example, the engaging portion 44 may be made of metal, while the engaged portion 4z may be made of a resin material. The engaging portion 44, which is used to engage with and disengage from a force output member 203, will thereby become more wear-resistant and have a higher hardness. In some embodiments, the engaging portion 44 and the engaged portion 4z may also be made of the same material.

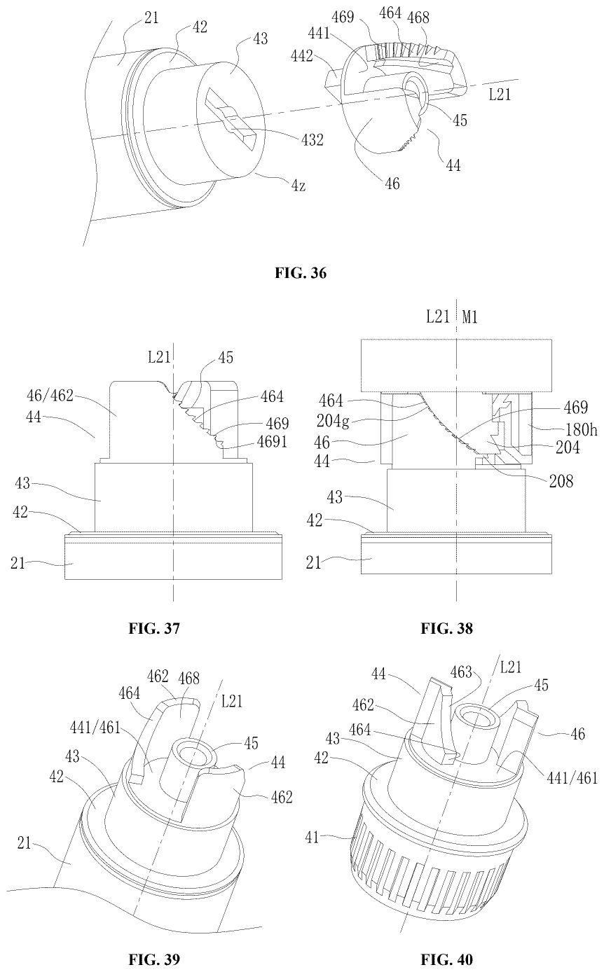

As shown in FIGS. 35, 36, 37, and 38, the engaging portion 44 is provided with a bottom plate 441 and a driving force transmission portion 442 extending from one side of the bottom plate 441. Correspondingly, the engaged portion 4z is provided with a movable cavity 432 that may engage with the driving force transmission portion 442, and a central pillar 45 and driving force receiving portions 46 are both formed by extending from the other side of the bottom plate 441, that is, the driving force receiving portions 46 are connected with the central pillar 45 through the bottom plate 441. Therefore, at least one part of the bottom plate 441 may also be appraised as a base 461.

Each driving force receiving portion 46 includes the base 461 and a convex block 462 located on a radial outer side of the central pillar 45, the convex block 462 is farther away from an axis of rotation L21 than the base 461, the driving force receiving portion 46 is configured to engage with a braking portion 203a, and when the force output member 203 rotates in the direction of rotation r, at least one of an outer output surface 204g and an inner output surface 208f of the corresponding braking portion 203a outputs a driving force to the driving force receiving portion 46.

Similar to Embodiment 16, a receding portion 468 is further formed between the driving surface 464 and the central pillar 45 in the radial direction perpendicular to the axis of rotation L21. Specifically, the receding portion 468 is arranged on the corresponding convex block 462, when a driving force receiving member 4 engages with the force output member 203, a second braking engagement member 208 enters the receding portion 468, while a first braking engagement member 204 is opposite to the driving surface 464. Therefore, there are three methods by which the force output member 203 outputs the driving force to the driving force receiving member 4:
First, the outer output surface 204g of the first braking engagement member 204 engages with the driving surface 464, while the second braking engagement member 208 is not in contact with a surface in the receding portion 468, and the driving force from the force output member 203 is transmitted from the first braking engagement member 204 to the driving force receiving member 4;
second, the outer output surface 204g of the first braking engagement member 204 does not engage with the driving surface 464, while the second braking engagement member 208 is in contact with the surface in the receding portion 468, the driving force from the force output member 203 is transmitted from the second braking engagement member 208 to the driving force receiving member 4, and as a result, a surface for receiving the driving force in each driving force receiving portion 46 will be the surface in the receding portion 468; and
third, the outer output surface 204g of the first braking engagement member 204 engages with the driving surface 464, while the second braking engagement member 208 is also in contact with the surface in the receding portion 468, the driving force from the force output member 203 is simultaneously transmitted from the first braking engagement member 204 and the second braking engagement member 208 to the driving force receiving member 4, and as a result, both the driving surface 464 and the surface in the receding portion 468 are the surfaces for receiving the driving force.

Further, each driving force receiving portion 46 further includes projections 469 arranged on the surface for receiving the driving force; when the driving force receiving member 4 engages with the force output member 203, the projections 469 engage with the braking portion 203a; during the process of the braking portion 203a outputting the driving force to the driving force receiving member 4, the braking portion 203a receives a reaction force from the driving force receiving member 4, which tends to disengage from the driving force receiving member 4. According to the arrangement of the above projections 469, the projections 469 may further be considered as one embodiment of the anti-disengagement portion 47, which may increase a friction force between the braking portion 203a and the driving force receiving member 4, thereby preventing the driving force receiving member 4 from disengaging from the braking portion 203a.

The surface (taking the driving surface 464 as an example) for receiving the driving force has a shape that fits with the outer output surface 204g and/or the inner output surface 208f, and a plurality of projections 469 are arranged on the surface for receiving the driving force. As shown in FIGS. 37 and 38, the surface for receiving the driving force is configured as a helical surface extending around the axis of rotation L21. When viewed in the direction perpendicular to the axis of rotation L21, the projections 469, as a whole, incline towards one side of a photosensitive drum 21/a connecting portion 41, and have surfaces 4691 facing the photosensitive drum 21/the connecting portion 41, thereby increasing the friction force between the force output member 203 and the driving force receiving member 4. Alternatively, the plurality of projections 469 may further be replaced with rough surfaces, elastic rubber, and the like.

When the engaging portion 44 and the engaged portion 4z do not need to be made of different materials, the engaging portion 44 and the engaged portion 4z may further be formed integrally, making the driving force receiving member 4 manufactured more easily.

### Embodiment 18

According to this embodiment, a structure of the convex block 462 is further simplified based on Embodiment 17. As shown in FIG. 39, a receding portion 468 is also formed between a driving surface 464 and a central pillar 45 in the radial direction perpendicular to an axis of rotation L21. However, the receding portion 468 is no longer formed on the corresponding convex block 462 but is located between the convex block 462 and the central pillar 45, that is, a space between the convex block 462 and the central pillar 45 constitutes the receding portion 468 in the radial direction perpendicular to the axis of rotation L21.

Upon the engagement of a driving force receiving member 4 with a force output member 203, a second braking engagement member 208 enters the receding portion 468; the driving surface 464, arranged on the convex block 462, is opposite to an outer output surface 204g; and a driving force output by the force output member 203 is transmitted from the outer output surface 204g to the driving surface 464.

Alternatively, the driving force receiving member 4 may be configured such that upon the engagement of the driving force receiving member 4 with the force output member 203, the driving surface 464 is opposite to an inner output surface 208f; and the driving force output by the force output member 203 is transmitted from the inner output surface 208f to the driving surface 464.

### Embodiment 19

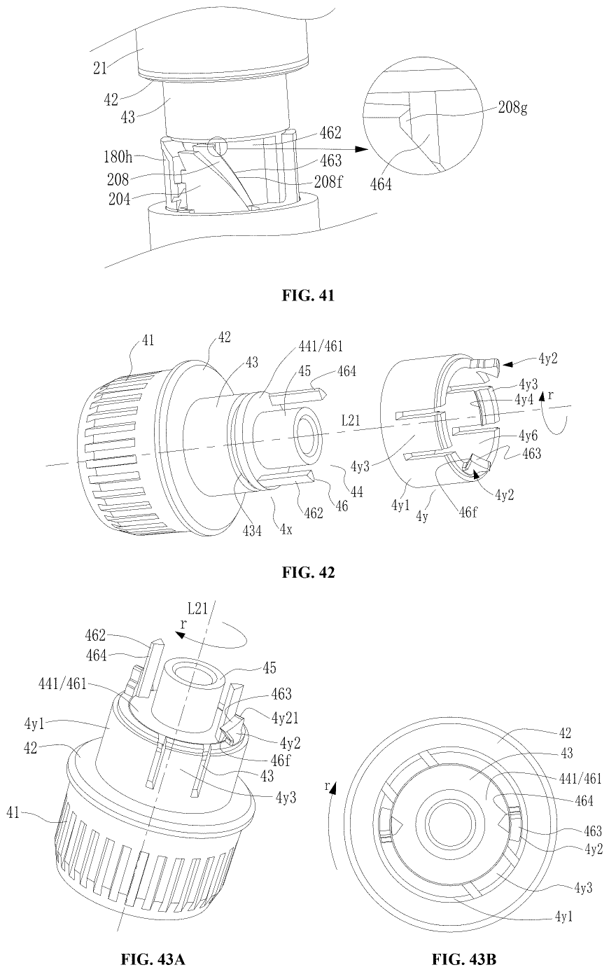

As shown in FIGS. 40 and 41, according to a structure of a force output member 203, a driving force receiving member 4 in this embodiment is configured such that upon the engagement of the driving force receiving member 4 with the force output member 203, the driving force receiving member 4 engages with a plane 208g of a second braking engagement member 208.

Each driving force receiving portion 46 includes a guide surface 463 arranged on a convex block 462 and a driving surface 464 adjacent to the guide surface 463, wherein the driving surface 464 is a surface that fits with the plane 208g. As shown in FIG. 40, the driving surface 464 is parallel to an axis of rotation L21.

Preferably, the guide surface 463 is configured as a helical surface extending around the axis of rotation L21. As shown in FIG. 41, during the engagement of the driving force receiving member 4 with the force output member 203, the guide surface 463 is guided by an outer output surface 204g or an inner output surface 208f, thus allowing the driving force receiving portion 46 to smoothly reach a position where the plane 208g is opposite to the driving surface 464. As the force output member 203 rotates, a driving force is transmitted from the plane 208g to the driving surface 464.

### Embodiment 20

A driving force receiving member 4 in this embodiment is configured such that upon the engagement of the driving force receiving member 4 with a force output member 203, the driving force receiving member 4 engages with a front surface 180g1 of a driving portion 180h.

If the driving force receiving member 4 engages with the force output member 203 in the manner as described in the above embodiment, where a driving force is output to the driving force receiving member 4 by a braking portion 203a, in the practical testing, an image forming apparatus will produce noise that is deemed unacceptable. Initial analysis indicates that the noise is caused by the collision between the driving portion 180h and the braking portion 203a, which are in close proximity, or caused due to the collision between a component of the force output member 203 and an inner wall of the image forming apparatus, or caused by the retraction of the braking portion 203a into a cylindrical portion 180c.

To achieve this, this embodiment provides the driving force receiving member 4 for eliminating the noise as described above. As shown in FIGS. 42, 43A, 43B, 44A, and 44B, the driving force receiving member 4 includes a connecting portion 41, a base tray 42, a main body portion 4x and an auxiliary member 4y, wherein the main body portion 4x is connected with the connecting portion 41 or the base tray 42, the auxiliary member 4y is configured to make a rotation relative to the main body portion 4x/a process cartridge casing/a photosensitive drum 21. Specifically, the main body portion 4x includes a substrate 43 connected with the connecting portion 41 or the base tray 42 and an engaging portion 44 arranged on the substrate 43, the engaging portion 44 includes a central pillar 45 and driving force receiving portions 46 extending outwards in the radial direction of the central pillar 45, an axis of rotation L21 passes through the central pillar 45, and each driving force receiving portion 46 includes a base 461 and a convex block 462, the convex block 462 is located on a radial outer side of the base 461 in the radial direction of the driving force receiving member 4/the engaging portion 44. As mentioned above, the engaging portion 44 further includes a bottom plate 441, and the central pillar 45 extends from one side of the bottom plate 441 along the axis of rotation L21, and the engaging portion 44 is connected with the substrate 43 through the bottom plate 441. In this embodiment, at least one part of the bottom plate 441 may be considered as the base 461.

The convex block 462 is configured as a cylindrical object extending along the axis of rotation L21, and a driving surface 464 for receiving the driving force is arranged on the convex block 462. Preferably, the main body portion 4x is integrated with the connecting portion 41 and the base tray 42, and the substrate 43 is also integrated with the engaging portion 44. The convex block 462 has a fourth surface 4621, the fourth surface 4621 is a surface of the convex block 462 that is farthest from the connecting portion 41 along the axis of rotation L21. As the convex block 462 extends beyond the central pillar 45 along the axis of rotation L21, the fourth surface 4621 serves as a tail end surface 4w of the driving force receiving member 4. Preferably, the fourth surface 4621 is a plane, and more preferably, the fourth surface 4621 is a plane that is perpendicular to the axis of rotation L21.

The auxiliary member 4y includes a bearing body 4y1, a separating member 4y2 projecting from the bearing body 4y1, and a limited portion 4y4 arranged on the bearing body 4y1 or the separating members 4y2. In some embodiments, the auxiliary member 4y/bearing body 4y1 sleeves the main body portion 4x, the main body portion 4x is further provided with a limiting portion 434 engaging with the limited portion 4y4, and through the engagement of the limited portion 4y4 with the limiting portion 434, the auxiliary member 4y is limited along the axis of rotation L21, while the auxiliary member 4y is not limited in a direction of rotation r. In some embodiments, the bearing body 4y1 is configured to be a ring body internally forming an accommodating cavity 4y6, and at least one part of the main body portion 4x is accommodated in the accommodating cavity 4y6; the limited portion 4y4 is configured to be a snap-fit projection projecting radially from the ring body 4y1 towards the accommodating cavity 4y6; and the limiting portion 434 is a snap-fit groove formed in an outer surface of the substrate 43 or the engaging portion 44, and the snap-fit groove 434 extends in the direction of rotation r. Conversely, the snap-fit groove may also be formed in the ring body 4y1, and the snap-fit projection may also be arranged on the substrate 43 or the engaging portion 44, where the snap-fit projection may extend completely in the direction of rotation r or extend only for a preset angle in the direction of rotation r.

In some embodiments, to facilitate the engagement of the snap-fit projection with the snap-fit groove 434, the auxiliary member 4y is further provided with an elastic arm 4y3 connected to the ring body 4y1, the snap-fit projection/the snap-fit groove 434 is arranged on the elastic arm 4y3, which may be deformed elastically relative to the ring body 4y1 utilizing the elastic arm 4y3, thereby facilitating the convenient engagement of the auxiliary member 4y with the main body portion 4x. Preferably, the elastic arm 4y3 is integrally formed with the ring body 4y1, and a gap is formed between the elastic arm 4y3 and the ring body 4y1, so that the elastic arm 4y3 may be deformed elastically relative to the ring body 4y1. More preferably, in the presence of the elastic arm 4y3, the snap-fit portion 4y4/the snap-fitted portion 434 is only arranged on the elastic arm 4y3, which in turn facilitates the more convenient engagement of the auxiliary member 4y with the main body portion 4x.

In some embodiments, the auxiliary member 4y may also sleeve the process cartridge casing, and the auxiliary member 4y may be provided with the limited portion 4y4. A limiting portion is arranged on the casing for restricting the limited portion 4y4, as long as it is ensured that the auxiliary member 4y may rotate around a direction parallel to the axis of rotation L21 and will not disengage from the casing. For example, the restriction on the auxiliary member 4y may be achieved by an abutment of the casing against a tail end surface of the auxiliary member 4y. Based on the inventive concept, the auxiliary member 4y may be mounted at various positions, for example, the auxiliary member 4y sleeves at least one of a charging member, a supplying member, and a stirring member.

In some embodiments, the auxiliary member 4y may further be rotationally mounted in a positioning groove reserved for the casing or the main body portion 4x. In such a structure, a component to support the auxiliary member 4y does not need to be arranged additionally in the positioning groove, the auxiliary member 4y may be positioned by an inner wall of the positioning groove, and accordingly, the bearing body 4y1 may further be configured to be a solid object as long as the bearing body 4y1 may rotate relative to the casing/photosensitive drum 21.

Preferably, when the auxiliary member 4y and the main body portion 4x are coaxial, the separating member 4y2 and the convex block 462 are spaced apart from each other in the radial direction of the driving force receiving member 4, and thus, the auxiliary member 4y with the separating member 4y2 may rotate freely around the axis of rotation L21.

Furthermore, the separating member 4y2 has a guide surface 463 and a hooked surface 46f, and the separating member 4y2 has a tip portion 4y21 that is furthest away from the connecting portion 41 along the axis of rotation L21, wherein the guide surface 463 is used to guide the separating member 4y2 to a preset position, the hooked surface 46f is configured to incline relative to the axis of rotation L21, and the inclined direction of the hooked surface 46f is such that when viewed in a direction that is perpendicular to the axis of rotation L21, the hooked surface 46f faces the connecting portion 41, and thus, the hooked surface 46f may prevent the braking portion 203a from moving towards a flange portion 180a, that is, the hooked surface 46f may prevent the force output member 203 from being separated from the driving force receiving member 4.

During the process of the driving force receiving member 4 moving towards the force output member 203, the guide surface 463 abuts against the braking portion 203a, enabling the braking portion 203a to move away from the driving portion 180h in the direction of rotation r. Subsequently, the separating member 4y2 enters, in the direction of rotation r, a third space K3 between the driving portion 180h and the braking portion 203a, where the separating member 4y2 is opposite to a driving force output surface 180d. Meanwhile, the convex block 462 reaches the downstream side of the front surface 180g1, which are located in a first space K1, where the front surface 180g1 is opposite to the driving surface 464.

When the force output member 203 begins to rotate, a driving force output by the driving portion 180h is transmitted to the driving force receiving 4 through the abutment of the front surface 180g1 against the driving surface 464. The hooked surface 46f engages with the braking portion 203a, and since the hooked surface 46f is configured to be an inclined surface as mentioned above, the braking portion 203a is “hooked” by the hooked surface 46f, without moving towards the flange portion 180a along the axis of rotation L21. The hooked surface 46f may also be considered as one embodiment of an anti-disengaging portion.

The driving portion 180h is separated from the braking portion 203a by the separating member 4y2, or at least one part of the separating member 4y2 enters the third space K3. When the driving force receiving member 4 in this embodiment receives the driving force output by the force output member 203, the noise caused by an image forming apparatus is eliminated; and accordingly, as long as the separating member 4y2 can enter the third space K3 and allow the driving portion 180h and the braking portion 203a to be separated from each other in the direction of rotation r, no hooked surface 46f will be required.

As mentioned above, in this embodiment, the separating member 4y2 is configured to be movable with the rotation of the bearing body 4y1 relative to the casing/photosensitive drum 21. Therefore, during the mounting and removal of the process cartridge C, the movable bearing body 4y1/separating member 4y2 improves the flexibility of mounting and removal of the process cartridge C, and reduces the risk of interference between the process cartridge C and the image forming apparatus.

### Embodiment 21

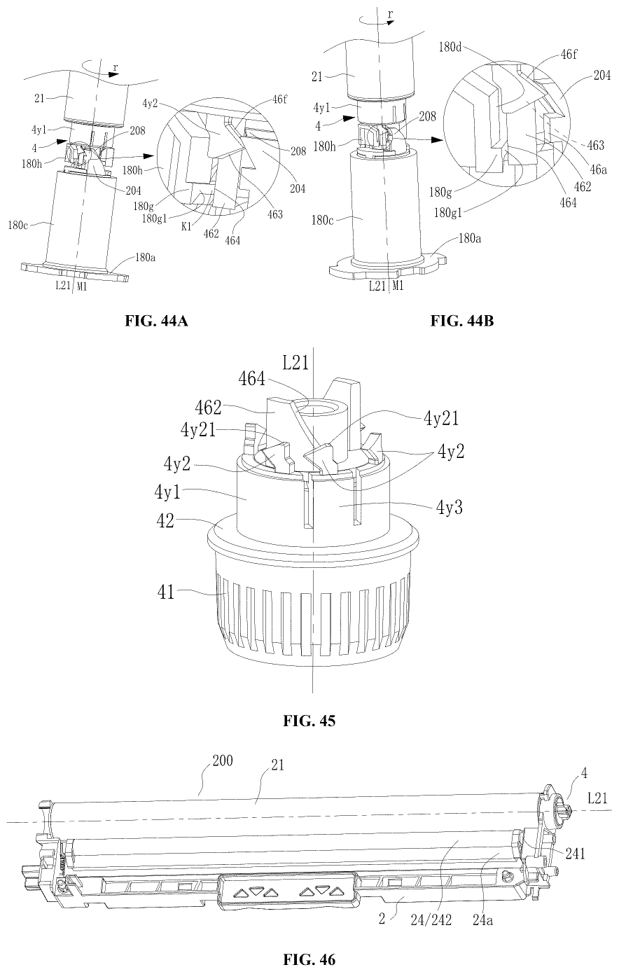

As shown in FIG. 45, an auxiliary member 4y is provided with a plurality of separating members 4y2 spaced apart from each other in a direction of rotation r. When a driving force receiving member 4 approaches a force output member 203 along an axis of rotation L21/M1, any one of the separating members 4y2 may enter a third space K3 along the axis of rotation L21/M1. After a convex block 462 with a driving surface 464 enters a second space K2, the driving force receiving member 4 may receive a driving force output by the force output member 203 smoothly, and noise caused by an image forming apparatus is eliminated.

In this embodiment, after the driving force receiving member 4 engages with the force output member 203, a braking surface 465 engages with a braking portion 203a, and with an inclined surface that the braking surface 465 has, the tendency of the braking portion 203a moving towards a flange portion 180a is stopped, and the driving surface 464 may stably receive the driving force.

Other separating members 4y2 among the plurality of separating members 4y2, other than the separating members 4y2 that enter the third space K3, may be considered as auxiliary projections, representing that multiple separating members 4y2 corresponding to the auxiliary projections may be provided; and the four auxiliary projections are spaced in a circumferential direction of the auxiliary member 4y. Preferably, the four auxiliary projections are evenly spaced in the circumferential direction of the auxiliary member 4y. The auxiliary projections 4y5 are used for assisting the separating members 4y2 and/or the driving surface 464 in reaching a preset position, where the separating members 4y2 enter the third space K3 in the direction of rotation r, the convex block 462 with the driving surface 464 enters the second space K2, and the driving surface 464 is opposite to at least one of an outer output surface 204g and an inner output surface 208f.

Furthermore, five or six separating members 4y2 may further be provided, which are evenly distributed in the circumferential direction of the auxiliary member 4y; when the number of the separating members 4y2 is less than four, it is possible that the separating members 4y2 may not enter the third space K3, resulting in mis-engagement; and when the number of the separating members 4y2 exceeds six, a failure in the smooth engagement of the driving force receiving member 4 with the force output member 203 may be caused by interference between the separating members 4y2 and the force output member 203.

### Embodiment 22

As described above, after a driving force receiving member 4 receives a driving force, a photosensitive drum 21 will be driven to rotate in a direction r1 in FIG. 47, a charging member 24 in contact with the photosensitive drum 21 is driven by friction force between a surface of the photosensitive drum 21 and a surface of the charging member 24 to rotate in a direction r2.

Generally, for the charging member 24 configured to make contact with the photosensitive drum 21 for charging, the charging member 24 includes a metal shaft 241 and an elastic material/coating 242 covering the metal shaft (as shown in FIG. 46). Apparently, the density of the metal shaft is greater than that of the elastic material, and accordingly, the inertia of the metal shaft is also greater than that of the elastic material. When the photosensitive drum 21 stops rotating, the charging member 24 will lose a power source, however, the metal shaft will, under the action of inertia, make the charging member 24 continue to rotate. As a result, the friction force between the surface of the charging member 24 and the surface of the photosensitive drum 21 may cause the photosensitive drum 21 to continue to rotate as well.

In some of the above embodiments, a braking portion 203a arranged in a force output member 203 applies a braking force to the driving force receiving member 4, which is used to drive the photosensitive drum 21 to rotate, to stop the potential continued rotation of the photosensitive drum 21. However, the structure of the force output member 203 with the braking portion 203a will become complex, which not only increases the manufacturing difficulty of an image forming apparatus and the driving force receiving member 4, but also enhances the control complexity of the image forming apparatus.

This embodiment provides a simple structure that may prevent the photosensitive drum 21 from continuing to rotate. As shown in FIGS. 46 and 47, a process cartridge C further includes a friction member 24a adjacent to and in contact with the charging member 24; the friction member 24a extends along an axis of rotation L21, when the charging member 24 loses the power source, the charging member 24 that continues to rotate due to inertia is propelled to stop rotating by the friction force between the friction member 24a and the charging member 24. Therefore, the risk of the photosensitive drum 21 continuing to rotate may be eliminated.

Conventionally, the friction member 24a may be configured as a sponge body, a rubber body, and other elastic components. When the charging member 24 is driven by the photosensitive drum 21 to rotate, the friction member 24a does not apply the excessive friction force to the charging member 24, resulting in an increase in a load of the charging member 24. However, when the charging member 24 is no longer driven by the photosensitive drum 21, the friction force between the friction member 24a and the charging member 24 is sufficient to stop rotating the charging member 24 that continues to rotate due to inertia.

During the operation of the process cartridge C, the high-speed rotation of the photosensitive drum 21 makes a developer on its surface separated from the photosensitive drum 21 under the action of a centrifugal force and reach the surface of the charging member 24; and the developer reaching the surface of the charging member 24 will reduce the charging efficiency of the charging member 24 for the photosensitive drum 21. The arrangement of the friction member 24a may also achieve the effect of cleaning the surface of the charging member 24. As the charging member 24 rotates, the developer reaching the surface of the charging member 24 may be adsorbed or scraped by the friction member 24a, and thus, the charging member 24 may efficiently charge the photosensitive drum 21.

### [Separation Contact Mechanism]

It is known that when the process cartridge C operates in the image forming apparatus (i.e., performing development operation), a developing roller 11 and the photosensitive drum 21 get close to each other. When the process cartridge C stops operating in the image forming apparatus (i.e., not performing development operation), the developing roller 11 needs to be separated from the photosensitive drum 21 to prevent a surface of the developing roller 11 from being impressed due to prolonged contact with the photosensitive drum 21, or the surface of the photosensitive drum 21 from being contaminated by the developer on the surface of the developing roller 11.

To this end, the present invention further provides a separation contact mechanism 5, which makes, depending on whether the process cartridge C is in an operation state or not in the image forming apparatus, the developing roller 11 and the photosensitive drum 21 get close to or separated from each other.

Before describing the separation contact mechanism 5, a separation control mechanism 93 that fits with the separation contact mechanism in the image forming apparatus is explained first in combination with FIG. 49. As shown in the figure, the separation control mechanism 93 is generally shaped like a Chinese character “ao” and extends in a front-rear direction. The separation control mechanism includes a separating force applying portion 93a located in the front and a restoring force applying portion 93b located in the rear, and a movable cavity 93c is formed therebetween.

After the process cartridge C reaches a preset position of the image forming apparatus, at least one part of the separation contact mechanism 5 enters the movable cavity 93c, however, the separation contact mechanism 5 does not make contact with the separation control mechanism 93, and at this moment, the separation control mechanism 93 is located at an intermediate position. When the process cartridge C does not need to operate in the image forming apparatus, the separation control mechanism 93 begins to move from front to rear; the separating force applying portion 93a makes contact with the separation contact mechanism 5 and applies a separating force to the separation contact mechanism 5, and the separating force applying portion 93a/separation control mechanism 93 reaches a separating force applying position; and subsequently, the separation control mechanism 93 begins to move from rear to front, as a result, the restoring force applying portion 93a is separated from the separation contact mechanism 5, but the developing roller 11 and the photosensitive drum 21 are still kept in a state where they are separated from each other. When the process cartridge C needs to operate again in the image forming apparatus, the separation control mechanism 93 continues to move from rear to front, the restoring force applying portion 93b makes contact with the separation contact mechanism 5 and applies a restoring force to the separation contact mechanism 5, and the restoring force applying portion 93b/separation control mechanism 93 reaches a restoring force applying position; and subsequently, the separation control mechanism 93 begins to move from front to rear, the restoring force applying portion 93b is separated from the separation contact mechanism 5 again, but the developing roller 11 and the photosensitive drum 21 are restored to a state where they make contact with each other.

That is, the separation control mechanism 93 may make reciprocating movement among the intermediate position, the separating force applying position, and the restoring force applying position in the front-rear direction, wherein the intermediate position is different from the separating force applying position and the restoring force applying position, the separating force applying position and the restoring force applying position are located on two sides of the intermediate position respectively, and the separation control mechanism 93 always returns to the intermediate position after applying an acting force (including the separating force and the restoring force) to an acting portion 51. Specifically, when the process cartridge C operates in the image forming apparatus, the separation control mechanism 93 is located at the intermediate position, at this moment, the developing roller 11 makes contact with the photosensitive drum 21. When the process cartridge C does not need to operate in the image forming apparatus, the separation control mechanism 93 first moves from the intermediate position to the separating force applying position, and then returns from the separating force applying position to the intermediate position, and at this moment, the developing roller 11 is separated from the photosensitive drum 21. When the process cartridge C needs to operate again in the image forming apparatus, the separation control mechanism 93 first moves from the intermediate position to the restoring force applying position, and then returns from the restoring force applying position to the intermediate position, and the developing roller 11 and the photosensitive drum 21 restore to the state where they make contact with each other.

### [First Separation Contact Mechanism]

The separation contact mechanism 5 is movably arranged on a left and/or right side of the process cartridge C. As shown in FIGS. 48 and 49, the separation contact mechanism 5, which is a rotating rod that is rotationally mounted in the process cartridge C, includes an acting portion 51, a main body 52, and a locking portion 53; the acting portion 51 is used to interact with the separation control mechanism 93, and is provided with a separating force receiving portion 511 and a restoring force receiving portion 512 that are arranged oppositely, the separating force receiving portion 511 is used to receive the separating force from the separation control mechanism 93 to separate the developing roller 11 from the photosensitive drum 21, while the restoring force receiving portion 512 is used to receive the restoring force from the separation control mechanism 93 to bring the developing roller 11 make contact with the photosensitive drum 21; when the acting portion 51 receives the separating force or the restoring force, the main body 52 drives the acting portion 51 and the locking portion 53 to rotate, and furthermore, the locking portion 53 engages with a locked portion arranged in the process cartridge C; and meanwhile, the rotating rod 5 propels the developing roller 11 to be separated from photosensitive drum 21.

In this embodiment, the rotating rod 5 is rotationally mounted at a tail end of a first unit casing 1, which is located between the first unit casing 1 and an end cover 300/400. As shown in the figure, the first unit casing 1 is provided with an arc-shaped guide rail 12 at its tail end, and the main body 52 of the rotating rod 5 is provided with a guide groove 54 that fits with the guide rail 12, and the guide groove 54 surrounds the guide rail 12; under the action of the separation control mechanism 93, the rotating rod 5 rotates along the guide rail 12, and a lower surface 541 of the guide groove 54 extrudes a lower surface 121 of the guide rail 12, which in turn drives a first unit 100 to rotate around an axis of rotation L of a first driving force receiving member 3, and at this moment, the developing roller 11 is separated from the photosensitive drum 21. As shown in FIG. 49, preferably, the guide groove 54 and the guide rail 12 are concentric with the development driving force receiving member 3; a straight line D is drawn in the front-and-rear direction of the process cartridge C, intersecting with the axis of rotation L, and the straight line D passes through the guide rail 12 to ensure the stable rotation of the rotating rod 5. More preferably, the straight line D passes through a center of a circular arc of the guide rail 12, and when the rotating rod 5 rotates, a force applied to the guide rail 12 is more uniform in the up-and-down direction, which not only facilitates stable rotation of the first unit 100 and the rotating rod 5, but also ensures the smoother rotation of the rotating rod 5.

Conversely, positions of the guide rail 12 and the guide groove 54 are reversible, such that the guide rail 12 is arranged on the main body 52, while the guide groove 54 is arranged on the casing 1. As the rotating rod 5 rotates, an upper surface of the guide rail 12 pushes against an upper surface of the guide groove 54, which in turn allows the first unit 100 to rotate, thereby achieving the separation of the developing roller 11 from the photosensitive drum 21.

It is achievable that the rotating rod 5 may also be provided with a thrusting portion, and accordingly, the first unit 100 is provided with a thrusted portion corresponding to the thrusting portion. As the rotating rod 5 rotates, the thrusting portion pushes the thrusted portion, making the first unit 100 rotate around the axis of rotation L, thereby separating the developing roller 11 from the photosensitive drum 21; and the thrusting portion and the thrusted portion may be solid bodies that make contact with each other, for example, the guide groove 54 may be considered as the thrusting portion, and the guide rail 12 may be considered as the thrusted portion. Of course, the thrusting portion and the thrusted portion may also be magnetic bodies with the same polar ends opposite to each other. As the rotating rod 5 rotates, a repulsive force between the thrusting portion and the thrusted portion gradually increases until the first unit 100 rotates around the axis of rotation L.

According to the inventive concept of this embodiment, the guide rail 12 may also be arranged on the end cover 300, and the developing roller 11 is separated from the photosensitive drum 21 under an interaction between the thrusting portion arranged on the rotating rod 5 and the thrusted portion arranged on the first unit 100. Conversely, a second unit 200 rotates around an axis of rotation L21 of a second driving force receiving member 4 through the rotation of the rotating rod 5 to separate the developing roller 11 from the photosensitive drum 21. The specific implementation may refer to the structure as described above that propels the first unit 100 to rotate, which will not be repeated here.

As shown in FIG. 49, the locking portion 53 includes a first projecting portion 531 arranged on the main body 52, and the locked portion includes a base body 22 arranged on the first unit 100 or the second unit 200 or the end cover 300, and a second projecting portion 23 projecting from the base body 22. When the separation control mechanism 93 moves from the intermediate position to the separating force applying position, the rotating rod 5 rotates in the direction r2, and the thrusting portion pushes the thrusted portion, thereby separating the developing roller 11 from the photosensitive drum 21. Meanwhile, the first projecting portion 531 passes over the second projecting portion 23 and reaches the front of the second projecting portion 23, thereby achieving the engagement/locking of the locking portion 53 with the locked portion. At this moment, even if the separation control mechanism 93 returns from the separating force applying position to the intermediate position, the developing roller 11 and the photosensitive drum 21 are still kept the state where they are separated from each other. When the separation control mechanism 93 moves from the intermediate position to the restoring force applying position, the rotating rod 5 rotates in the direction against the direction r2, the first projecting portion 531 passes over the second projecting portion 23 again and reaches the rear of the second projecting portion 23, achieving the unlocking of the locking portion 53 from the locked portion. Under the action of a compression spring C3 (as shown in FIG. 3A) between the first unit 100 and the second unit 200, the developing roller 11 and the photosensitive drum 21 restore to the state where they make contact with each other.

Preferably, one end of the base body 22 is fixed to one of the first unit 100, the second unit 200, and the end cover 300, while the other end thereof is in a suspended state. Therefore, the base body 22 has a certain amount of elastic deformation, locking and unlocking are easily accessible, and a friction force between the locking portion 53 and the locked portion is smaller.

As mentioned above, both the locking portion 53 and the locked portion are arranged away from the acting portion 51. Specifically, both the locking portion 53 and the locked portion are arranged above the process cartridge in the up-and-down direction, that is, a locking assembly including the locking portion 53 and the locked portion, and the acting portion 51 are respectively located on both sides of the process cartridge in the up-and-down direction, and the locking assembly constitutes a part of the separation contact mechanism 5. On one hand, when the separation control mechanism 93 applies the acting force to the acting portion 51, there is no need to worry about unnecessary interference between the separation control mechanism 93 and the locking assembly, on the other hand, the locking portion 53 is arranged on the rotating rod 5, and the locking or unlocking of the locking portion 53 and the locked portion may be achieved by the rotation of the rotating rod 5. Such operation not only improves the efficiency of locking and unlocking, but also simplifies the structure of the process cartridge, which is conducive to improving the assembly efficiency of the process cartridge.

### [Second Separation Contact Mechanism]

As shown in FIG. 50, the process cartridge C further includes a protecting cover 14 mounted at one tail end of the first unit 100; a part of the development driving force receiving member 3 is located between the first unit casing 1 and the protecting cover 14 to be protected; the protecting cover 14 is fixedly mounted on the casing 1, and the separation contact mechanism 5 extends downward from the protecting cover 14; and the acting portion 51 is formed on a lower part of the separation contact mechanism 5, and the separating force receiving portion 511 and the restoring force receiving portion 512, which are distributed oppositely in the front-rear direction, are located on the acting portion 51. Therefore, when the separating force or the restoring force is applied to the separation contact mechanism 5, the separation contact mechanism 5 may drive the protecting cover 14 to move, the protecting cover 14 then drives the first unit casing 1 to move, and finally, the developing roller 11 is separated from or makes contact with the photosensitive drum 21.

Wherein, the separation contact mechanism 5 and the protecting cover 14 may be formed either as an integral member or separated members, and furthermore, the protecting cover 14 may also be considered as a part of the separation contact mechanism 5, for example, the protecting cover 14 derives from a variant of the main body 52 of the separation contact mechanism 5. In the event that the separation contact mechanism 5 and the protecting cover 14 are formed as separated members, the two members may be either fixedly or movably connected, provided that the separation contact mechanism 5 is capable of transmitting the received separating force or restoring force to the protecting cover 14, and allowing the developing roller 11 to be separated from or make contact with the photosensitive drum 21.

Like the first separation contact mechanism, the locking portion 53 is arranged above the protecting cover 14, the locked portion is arranged on the first unit 100 or the second unit 200 or the end cover 300, the locking portion 53 includes a first projecting portion 531, the locked portion includes a base body 22 and a second projecting portion 23 projecting from the base body 22, the locking portion 53 engages with the locked portion to keep the developing roller 11 and the photosensitive drum 21 in the state where they are separated from each other as the separating force receiving portion 511 receives the separating force, and the locking portion 53 and the locked portion are unlocked to restore the developing roller 11 and the photosensitive drum 21 to the state where they make contact with each other as the restoring force receiving portion 512 receives the restoring force.

Similar to the first separation contact mechanism, in this embodiment, the locking portion 53 and the locked portion are arranged away from the acting portion 51. This arrangement still fulfills the objectives of preventing unnecessary interference between the separation control mechanism 93 and the locking assembly, and simplifying the structure of the process cartridge to enhance the assembly efficiency of the process cartridge.

Furthermore, the locking portion 53 is fixed relative to the first unit casing 1. Both the structure of the contact separation mechanism 5 and the structure of the process cartridge C are simplified. When the acting portion 51 receives the acting force applied by the separation control mechanism 93, the locking portion 53 may be directly controlled without transmitting the acting force through a movable component, thereby rendering the contact separation mechanism 5 with this structure highly reliable.

### [Third Separation Contact Mechanism]

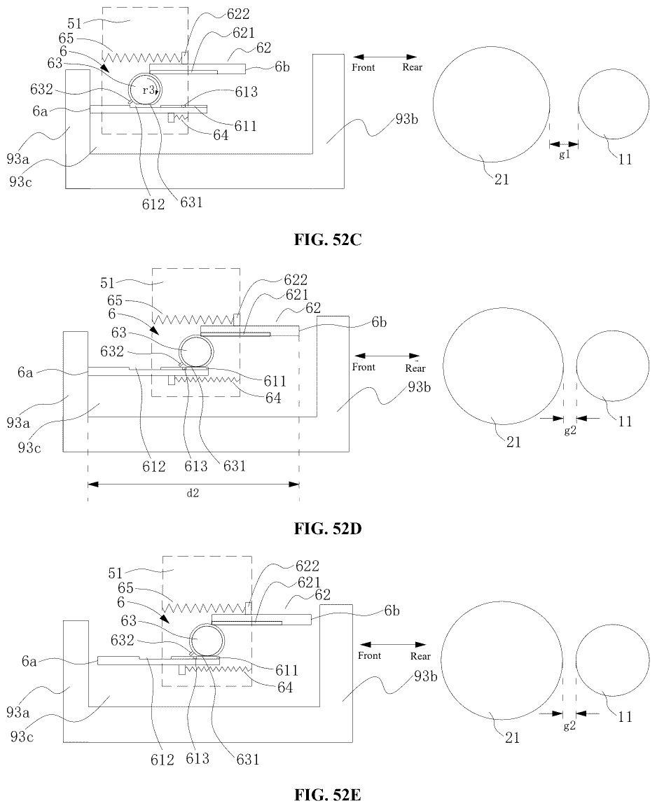

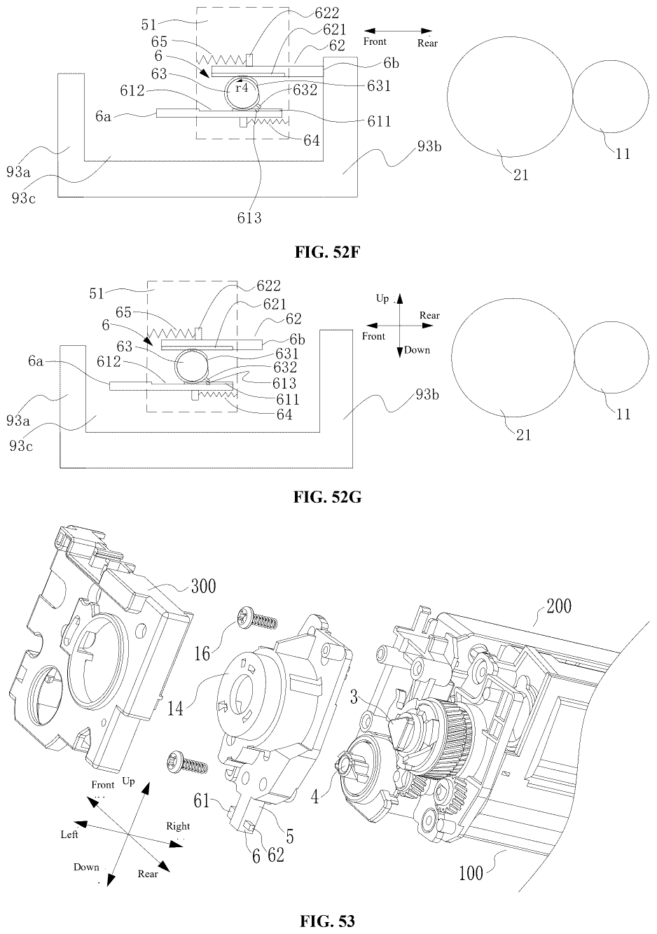

As shown in FIG. 51, the separation contact mechanism 5, including the main body 52 and the acting portion 51 arranged on the main body, in this embodiment is mounted in a movable manner. When the acting portion 51 receives the separating force from the separation control mechanism 93, the acting portion 51 itself or a component linked with the acting portion allows the first unit 100 to rotate around the axis of rotation L in the direction r2, thereby separating the developing roller 11 from the photosensitive drum 21; and a part of the acting portion 51 abuts against the separation control mechanism 93 for locking, and the developing roller 11 and the photosensitive drum 21 are kept in the state where they are separated from each other. When the acting portion 51 receives the restoring force from the control separation mechanism 93, the locking state of the acting portion 51 is released, the first unit 100 rotates around the axis of rotation L in the direction against the direction r2, thereby bringing the developing roller 11 to make contact with the photosensitive drum 21. Specifically, the separation contact mechanism 5 further includes the locking assembly 6 arranged in the acting portion 51, and the movement process of the locking assembly 6 will be described with reference to FIGS. 52A-52G.

The locking assembly 6 includes a first movable member 61, a second movable member 62, and a rotating member 63, wherein both the first movable member 61 and the second movable member 62 extend in the front-rear direction and may make movement in the front-rear direction after receiving the acting force from the separation control mechanism 93; the rotating member 63 is used to connect the first movable member 61 and the second movable member 62; and after one of the first movable member 61 and the second movable member 62 is subjected to the acting force, the rotating member 63 transmits the acting force to the other movable member. The locking assembly 6, as a whole, forms a linkage, and moreover, when the developing roller 11 makes contact with or is separated from the photosensitive drum 21, the rotating member 63 remains locked with at least one of the first movable member 61 and the second movable member 62. In the following text, an example is provided where the rotating member 63 may remain locked with the first movable member 61.

As shown in FIG. 52A, the locking assembly 6 further includes a first elastic member 64 that abuts against the first movable member 61 and a second elastic member 65 that abuts against the second movable member 62; when the process cartridge C reaches the preset position of the image forming apparatus, the acting portion 51 enters the movable cavity 93c; neither the first movable member 61 nor the second movable member 62 makes contact with the separation control mechanism 93 within the image forming apparatus; at least one of the first movable member 61 and the second movable member 62 serves as a rack; the rotating member 63 includes a gear that engages with the rack and a stop portion 632 connected to the gear directly or indirectly; and an empty portion 631 is arranged adjacent to the stop portion 632, and the stop portion 632 may rotate with the rotation of the gear.

The first movable member 61 is provided with a toothed portion 611 and a toothless portion 612 which are distributed adjacent to each other, and the second movable member 62 is provided with a toothed portion 621. As shown in FIG. 52A, at the initial stage, the developing roller 11 makes contact with the photosensitive drum 21, a front tail end (first force-receiving end) 6a of the first movable member 61 and a rear tail end (second force-receiving end) 6b of the second movable member 62 are located outside the acting portion 51, a distance between the first force-receiving end 6a and the second force-receiving end 6b is d1 in the front-rear direction, and alternatively, the dimension of the locking assembly 6 in the front-rear direction is d1; the gear of the rotating member engages with both the toothed portion 611 of the first movable member and the toothed portion 621 of the second movable member; at least the first elastic member 64 in the first elastic member 64 and the second elastic member 65 is in an elastic deformation state; and the stop portion 632 engages with the toothed portion 611 of the first movable member behind the gear of the rotating member. Although the first elastic member 64 has a tendency to push the first movable member 61 forward or the second elastic member 65 has a tendency to push the second movable member 62 backward, the locking assembly 6 generally remains stationary in the self-locking state under the interaction between the stop portion 632 and the tooth portion 611 of the first movable member.

When the process cartridge C does not need to operate in the image forming apparatus, the separation control mechanism 93 moves from the intermediate position towards the separating force applying position. As shown in FIG. 52B, the separating force applying portion 93a begins to make contact with the front tail end (first force-receiving end) 6a of the first movable member 61, and at this moment, the developing roller 11 and the photosensitive drum 21 are still kept in the state where they make contact with each other. As the separation control mechanism 93 pushes and compresses the first force-receiving end 6a backward, the first movable member 61 moves backward, and the first elastic member 64 is elastically deformed. When the stop portion 632 is opposite to the toothless portion 612, the rotating member 63 rotates in the direction r3 in FIG. 52C. As shown in FIG. 52C, the first movable member 61 has a tendency to move forward under the elastic force of the first elastic member 64, and meanwhile, the gear of the rotating member and the elastic force of the second elastic member 65 both drive the second movable member 62 to move backward; the second force-receiving end 6b abuts against an abutted portion 15 arranged on the first unit 100, thereby allowing the first unit 100 to rotate around the axis of rotation L in the direction r2; and the developing roller 11 is separated from the photosensitive drum 21, and a first gap g1 is formed therebetween. Apparently, the elastic force of the second elastic member 65 is greater than that of a compression spring C3.

As shown in FIG. 52D, after applying the separating force to the locking assembly 6, the separation control mechanism 93 begins to move from the separating force applying position towards the intermediate position, the first elastic member 64 releases the elastic force, and the first movable member 61 moves forward following the separation control mechanism 93. During the process in which the stop portion 632 passes through the toothless portion 612, the second movable member 62 slightly moves forward by a certain distance under a reaction force of the first unit 100, while the developing roller 11 remains separated from the photosensitive drum 21. However, the distance between them is reduced to g2 as shown in FIG. 52D, the stop portion 632 engages with the toothed portion 611 of the first movable member in front of the gear of the rotating member, the first force-receiving end 6a remains abutted against the separating force applying portion 93a, the first movable member 61 is locked, and correspondingly, the second movable member 62 also no longer moves. At this moment, the dimension of the locking assembly 6 in the front-rear direction is d2, which satisfies d2>d1.

When the process cartridge C needs to begin to operate again in the image forming apparatus. As shown in FIG. 52E, the separation control mechanism 93 begins to move from the intermediate position towards the restoring force applying position, at this moment, the developing roller 11 still remains separated from the photosensitive drum 21, and the stop portion 632 is opposite to a fitting groove 613 formed in the first movable member. As shown in FIG. 52F, the restoring force applying portion 93b begins to abut against the second movable member 62. Under the action of the restoring force applying portion 93b, the second movable member 62 drives the rotating member 63 to rotate in the direction r4 in the figure. Meanwhile, the rotating member 63, through the fitting between the stop portion 632 and the fitting groove 613, drives the first movable member 61 to move backward, the second elastic member 65 is elastically deformed again, the first unit 100 is no longer abutted, and thus, the developing roller 11 and the photosensitive drum 21 return to the position where they make contact with each other.

As the separation control mechanism 93 moves forward by a preset distance and begins to move from the restoring force applying position towards the intermediate position; as shown in FIG. 52G, the second movable member 62 stops moving forward, the rotating member 63 and the first movable member 61 also stop moving synchronously; and furthermore, the locking portion 632 engages with the toothed portion 611 of the first movable member behind the gear of the rotating member again, and the locking assembly generally remains stationary in the self-locking state again.

As mentioned above, the stop portion 632 may also engage with the toothed portion 621 of the second movable member 62 to lock the second movable member 62, and at this moment, the toothless portion is further arranged on the second movable member 62. When the developing roller 11 makes contact with the photosensitive drum 21, the locking portion 632 engages with the toothed portion 621 of the second movable member in front of the gear of the rotating member. When the developing roller 11 is separated from the photosensitive drum 21, the locking portion 632 engages with the toothed portion of 621 of the second movable member behind the gear of the rotating member.

Optionally, the locking portion 632 and the empty portion 631 may be arranged on a rotary body that is coaxial with the gear of the rotating member, where a diameter of the rotary body is greater than that of the gear of the rotating member; and alternatively, the empty portion 631 is not required, and the diameter of the rotary body is set to be smaller than that of the gear of the rotating member, with the stop portion 632 projecting from the rotary body, provided that the stop portion 632 may engage with the first movable member 61 or the second movable member 62 when the developing roller 11 makes contact with or is separated from the photosensitive drum 21, making the locking assembly 6 remain in the self-locking state.

Similarly, the separation contact mechanism 5 may also be arranged on the second unit 200 or the end cover 300. When the separation contact mechanism 5 is arranged on the second unit 200, the locking component 6 allows the second unit 200 to rotate around the axis of rotation L21, thereby separating the developing roller 11 from the photosensitive drum 21. When the separation contact mechanism 5 is arranged on the end cover 300, the locking assembly 6 may not only enable the first unit 100 to rotate around the axis of rotation L, but also allows the second unit 200 to rotate around the axis of rotation L21, which may ultimately separate the developing roller 11 from the photosensitive drum 21.

Preferably, the first movable member 61 and the second movable member 62 are configured to be the racks. Alternatively, the first movable member 61 and the second movable member 62 may further be configured to have surfaces such as frosted surfaces and rubber surfaces. Outer surfaces of teeth of the gear in the rotating member 63 may also be replaced with the frosted surfaces and the rubber surfaces, provided that the acting force may be transmitted between the first movable member 61 and the second movable member 62, and moreover, when the developing roller 11 makes contact with or is separated from the photosensitive drum 21, the stop portion 632 abuts against the first movable member 61 or the second movable member 62, thereby making the locking assembly 6 remain in the self-locking state as a whole.

Furthermore, in order to prevent interference between the separation contact mechanism 5 and an inner wall of the image forming apparatus during the movement of the process cartridge C towards the preset position of the image forming apparatus, before the process cartridge C in this embodiment reaches the preset position, the separation contact mechanism 5 is in the “retracted” state. In this way, regardless of whether the process cartridge C moves directly down to the preset position or is pre-mounted downward and then moves forward to the preset position, the separation contact mechanism 5 will not touch the inner wall of the image forming apparatus.

As shown in FIG. 51, an upper tail end of the main body 52 is provided with a pressed portion 57, and the main body 52 is also provided with a movable groove 55 and an elastic member (not shown) mounted in the movable groove 55; a support body 13 is arranged at a longitudinal tail end of the first unit casing 1, one end of the elastic member abuts against the support body 13, and the other end abuts against a tail end of the movable groove 55; under an elastic force of the elastic member, the separation contact mechanism 5, as a whole, is pushed upward to a position not exceeding the first unit 100, the second unit 200, and the bottom of the end cover 300; the acting portion 51 is not allowed to interfere with the separation control mechanism 93; after the process cartridge C reaches the preset position, the pressed portion 57 is pressed by means of a top plate of the image forming apparatus, for example, a pressing mechanism may be the top plate 94 linked with a door cover of the image forming apparatus; when the door cover is closed, the top cover 94 presses the pressed portion 57, and the separation contact mechanism 5 overcomes the elastic force of the elastic member to allow at least the acting portion 51 to “extend”, i.e., to extend beyond the first unit 100, the second unit 200, and the bottom of the end cover 300; and the acting portion 51 enters the movable cavity 93c of the separation control mechanism 93 and is capable of receiving the acting force applied by the separation control mechanism 93. It could be understood that at least the acting portion 51 of the separation contact mechanism 5 is configured to extend and retract in the up-and-down direction, and such a configuration may also be applied to the first separation contact mechanism and the second separation contact mechanism.

In this embodiment, the locking assembly 6 is arranged in the acting portion 51. Similarly, when the separation control mechanism 93 applies the acting force to the acting portion 51, there is no need to worry about unnecessary interference between the separation control mechanism 93 and the locking assembly 6. Although the separation control mechanism 93 fulfills the objective of controlling the developing roller 11 and the photosensitive drum 21 to be close to or away from each other by applying the acting force to the locking assembly 6, when the locking assembly 6 does not need to receive the acting force, the separation control mechanism 93 will not interfere with the locking assembly 6, wherein the unnecessary interference refers to interference, that occurs, between the separation control mechanism 93 and the locking assembly 6 when the locking assembly 6 does not need to receive the acting force. Furthermore, the locking assembly 6 is arranged in the acting portion 51, which also achieves the effects of simplifying the structure of the process cartridge C and improving the assembly efficiency of the process cartridge.

### [Fourth Separation Contact Mechanism]

In this embodiment, the fourth separation contact mechanism 5 is of a substantially identical structure to the third separation contact mechanism, with the difference in that in this embodiment, the separation contact mechanism 5 is connected to the protecting cover 14. When the developing roller 11 needs to be separated from the photosensitive drum 21, the position of abutment for the second movable member 62 of the locking assembly 6 is altered.

As shown in FIGS. 53 and 54, both the first movable member 61 and the second movable member 62 extend from the acting portion 51, which are respectively used for engaging with the separating force applying portion 93a and the restoring force applying portion 93b of the separation control mechanism 93. In this embodiment, the second movable member 62 is further provided with a drive projection 622 (as shown in FIGS. 52A-52G), and the movement process of the locking assembly 6 in this embodiment is the same as that of the third separation contact mechanism. Therefore, the movement process of the locking assembly 6 is not described repeatedly. It needs to be mentioned that unlike the above embodiment, the separating force applied by the separating force applying portion 93a is transmitted from the drive projection 622 to the acting portion 51, and is then transmitted from the acting portion 51 to the protecting cover 14, and finally, the protecting cover 14 drives the first unit 100 to rotate around the axis of rotation L in the direction r2, thereby separating the developing roller 11 from the photosensitive drum 21.

### [Fifth Separation Contact Mechanism]

In this embodiment, the separating force applied by the separating force applying portion 93a is still transmitted from the acting portion 51 to the protecting cover 14 firstly, and the protecting cover 14 then drives the first unit 100 to rotate around the axis of rotation L in the direction r2, thereby separating the developing roller 11 from the photosensitive drum 21.

As mentioned above, during the mounting of the process cartridge C towards the preset position in the image forming apparatus, at least the acting portion 51 of the separation contact mechanism 5 is configured to move in the up-and-down direction of the process cartridge C in order to prevent interference between the separation contact mechanism 5 and the inner wall of the image forming apparatus. Before the process cartridge C is mounted to the preset position of the image forming apparatus, the separation contact mechanism 5 remains in the retracted state. When the process cartridge C reaches the preset position of the image forming apparatus and is extruded by the inner wall of the image forming apparatus, the separation contact mechanism 5 extends, and at least the acting portion 51 enters the movable cavity 93c for receiving the acting force applied by the separation control mechanism 93.

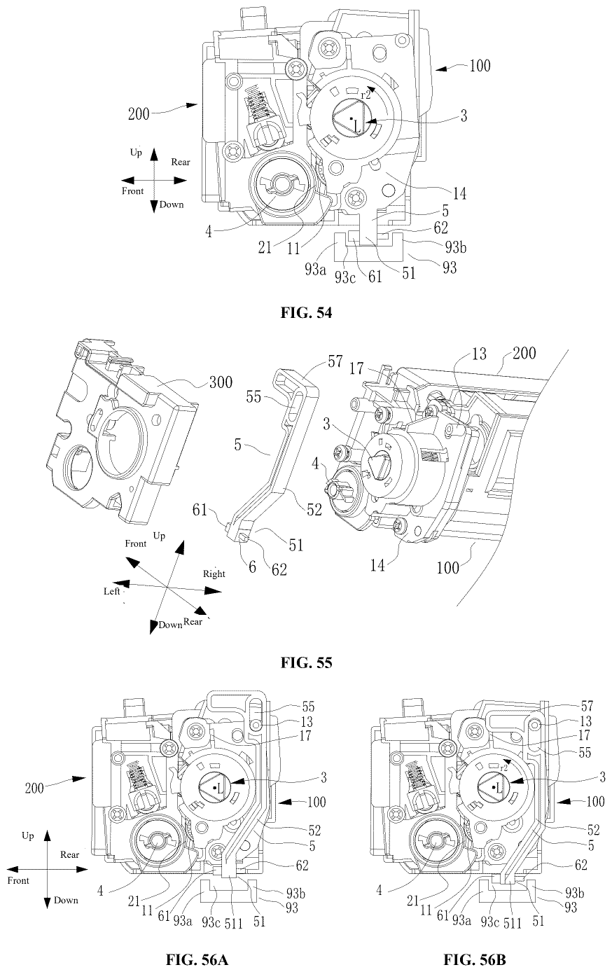

As shown in FIG. 55, the main body 52 is further provided with the movable groove 55 and the pressed portion 57 as shown in FIG. 51, one end of the elastic member (not shown) abuts against the movable groove 55, and the other end abuts against the support body 13. The pressed portion 57 has a larger length in the front-rear direction than that it has in the above embodiment. As shown in FIGS. 56A and 56B, when the pressed portion 57 is pressed by the inner wall of the image forming apparatus, the pressed portion 57 may engage with a rib 17 on the protecting cover 14. When the separating force applying portion 93c applies the separating force to the locking assembly 6, the first movable member 61 is locked, and the separating force is transmitted from the drive projection 622 to the main body 52, making the main body 52 rotate in the counter-clockwise direction around the support body 13. Meanwhile, the pressed portion 57 pushes the rib 17, allowing the first unit 100 to rotate around the axis of rotation L in the direction r2, thereby separating the developing roller 11 from the photosensitive drum 21. In contrast, when the restoring force applying portion 93b applies the restoring force to the locking assembly 6, the first movable member 61 is unlocked, the first unit 100 rotates, under the action of the compression spring C3, around the axis of rotation L in the direction against the direction r2, and the developing roller 11 and the photosensitive drum 21 restore to the state where they make contact with each other.

As mentioned above, after the separation control mechanism 93 in the image forming apparatus applies the separating force and the restoring force to the separation contact mechanism 5, the separation control mechanism may return to the intermediate position where it no longer contacts the separation contact mechanism 5; when the separation control mechanism 93 applies the acting force (including the separating force and the restoring force) to the separation contact mechanism 5, the corresponding components (the separating force applying portion 93a and the restoring force applying portion 93b) of the separation control mechanism 93 have reduced movement distance, which is advantageous for reducing the size of the image forming apparatus. Furthermore, the separation contact mechanism 5 of the present invention has the locking function, after the developing roller 11 is separated from the photosensitive drum 21, the separation contact mechanism 5 is locked, and even if the image forming apparatus sways by an external force, the developing roller 11 and the photosensitive drum 21 may also remain in the stable state where they are separated from each other.

Similar to the third separation contact mechanism, the locking assemblies 6 in this embodiment and the fourth separation contact mechanism are also arranged in the acting portion 51. Therefore, there is no unnecessary interference between the separation control mechanism 93 and the locking assembly, and the structure of the process cartridge C is also simplified. Correspondingly, the assembly efficiency of the process cartridge may also be improved.

### [Sixth Separation Contact Mechanism]

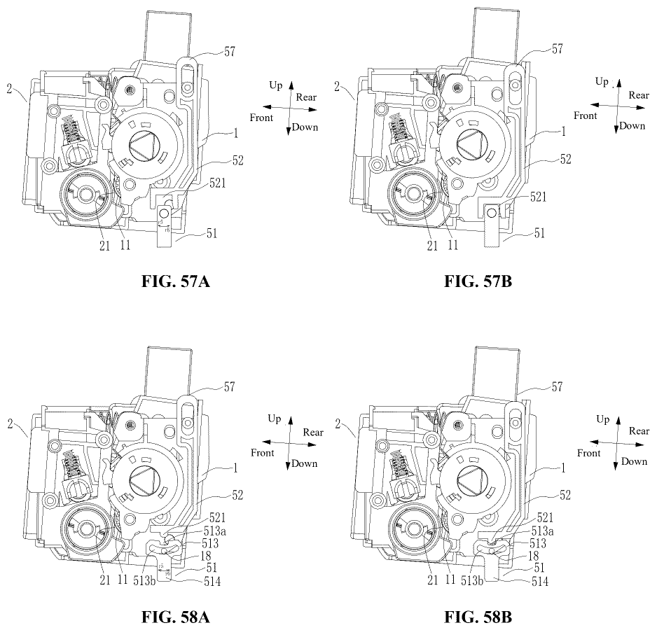

As shown in FIGS. 57A and 57B, the separation contact mechanism 5 in this embodiment includes the main body 52 and the acting portion 51 which are formed as separated members, the pressed portion 57 is located at an upper tail end of the main body 52, and an intermediate portion 521 that may engage with the acting portion 51 is arranged at a lower tail end of the main body 52; and the acting portion 51 is rotationally arranged at longitudinal tail ends of the process cartridge, for example, the acting portion 51 is arranged at the longitudinal tail end of the first unit casing 1 through fits for shafts and holes.

Before the pressed portion 57 is pressed by the top plate of the image forming apparatus, the intermediate portion 521 is located at a first position where it does not engage with the acting portion 51, and the acting portion 51 remains in a drooping state under the action of gravity. Regardless of whether the process cartridge C is mounted towards the image forming apparatus or removed from the image forming apparatus, and even if the components in the image forming apparatus interfere with the acting portion 51, the acting portion 51 may still rotate in the direction r5 or r6 in FIG. 57A.

When the pressed portion 57 is pressed by the top plate of the image forming apparatus, the intermediate portion 521 is located at a second position where it engages with the acting portion 51, an angle of rotation of the acting portion 51 is limited, or the acting portion 51 is unable of rotating due to the limitation by the intermediate portion 521. However, the acting portion 51 may still receive the acting force applied by the separation control mechanism 93 in two different directions, one of which is the separating force that separates the developing roller 11 from the photosensitive drum 21, while the other one is the restoring force that makes the developing roller 11 get close to the photosensitive drum 21. Preferably, the separation receiving mechanism 5 is further provided with a holding member, after the separation control mechanism 93 applies the separating force to the separation receiving mechanism 5, the separation control mechanism 93 disengages from the separation receiving mechanism 5, and at this moment, the state where the developing roller 11 is separated from the photosensitive drum 21 is kept by the holding member. When the pressed portion 57 is no longer pressed by the top plate, the intermediate portion 521 returns from the second position to the first position.

However, in some embodiments, the holding member may also be removed, and after the separation control mechanism 93 applies the separating force to the separation receiving mechanism 5, the separation control mechanism 93 does not disengage from the separation receiving mechanism 5, and the state where the developing roller 11 is separated from the photosensitive drum 21 is kept under the interaction between the separation control mechanism 93 and the separation receiving mechanism 5.

### [Seventh Separation Contact Mechanism]

As shown in FIGS. 58A and 58B, unlike the sixth separation contact mechanism, in this embodiment, before the pressed portion 57 is pressed by the top plate of the image forming apparatus, the angle of rotation of the acting portion 51 is limited, which may prevent the situation that the acting portion 51 rotates excessively, resulting in inability to restore to the drooping state. As shown in the figure, the acting portion 51 includes a rotating portion 513 and an acting force receiving portion 514 which engage with each other, and the acting portion 51 is rotationally arranged at the longitudinal tail end of the first unit casing 1 via the rotating portion 513. Specifically, a limiting groove 513b is formed in the rotating portion 513, the first unit 100 is provided with a positioning projection 18 which fits with the limiting groove 513b, and the angle of rotation of the acting portion 51 is limited by a length of the limiting groove 513b. Conversely, the position of the limiting groove 513b and the position of the positioning projection 18 are reversible. Furthermore, the rotating portion 513 is further provided with a fitting portion 513a which is used to fit with the intermediate portion 521.

Before the pressed portion 57 is pressed by the top plate of the image forming apparatus, the intermediate portion 521 does not engage with the fitting portion 513a, and the acting portion 51 remains in the drooping state under the action of gravity. Regardless of whether the process cartridge C is mounted towards the image forming apparatus or removed from the image forming apparatus, and even if the components in the image forming apparatus interfere with the acting portion 51, the acting portion 51 may still rotate in the direction r5 or r6 in FIG. 58A. However, the angle of rotation of the acting portion 51 is limited by contact between the positioning projection 18 and the limiting groove 513b.

When the pressed portion 57 is pressed by the top plate of the image forming apparatus, the intermediate portion 521 engages with the acting portion 51, the angle of rotation of the acting portion 51 is limited, or the acting portion 51 is limited by the intermediate portion 521, resulting in failure to rotate. However, the acting portion 51/acting force receiving portion 514 may still receive the acting force applied by the separation control mechanism 93.

What is claimed is:

1. A driving force receiving member, configured for being mounted on a rotating member, wherein the driving force receiving member receives a driving force from an image forming apparatus and drives the rotating member to rotate, and the driving force receiving member comprises: a convex block, comprising:
a first surface, extending in a direction of an axis of rotation of the driving force receiving member; and
a contact surface, configured as an inclined surface inclined with respect to the axis of rotation of the driving force receiving member;
wherein in a direction of rotation of the driving force receiving member, a starting position o f an extension of the contact surface is flush with the first surface or located on a downstream side of the first surface.

2. The driving force receiving member according to claim 1, wherein the driving force receiving member further comprises a connecting portion engaged with the rotating member, and an engaging portion extending from the connecting portion, wherein the engaging portion comprises a central pillar and the convex block, and the convex block is located on a radial outer side of the central pillar in a radial direction perpendicular to the axis of rotation.

3. The driving force receiving member according to claim 2, wherein the engaging portion further comprises a pressing portion, wherein, in the direction of the axis of rotation, the convex block extends further from the connecting portion than the pressing portion, and a tail end surface of the pressing portion is configured as a pressing surface.

4. The driving force receiving member according to claim 3, wherein the central pillar, the pressing portion, and the convex block are sequentially located away from the axis of rotation in the radial direction perpendicular to the axis of rotation.

5. The driving force receiving member according to claim 1, wherein the convex block further comprises a second surface, wherein, in the direction of rotation of the driving force receiving member, the first surface and the second surface are oppositely arranged, and the first surface is located on an upstream side of the second surface.

6. The driving force receiving member according to claim 5, wherein when measured in a di rection perpendicular to the axis of rotation, distances between the axis of rotation and outermost points in a radial direction of the contact surface, the first surface and the second surface respectively are equal.

7. The driving force receiving member according to claim 5, wherein the first surface and the second surface are both parallel to the axis of rotation.

8. The driving force receiving member according to claim 2, wherein the driving force receiving member is configured to receive a driving force from a force output member in the image forming apparatus, wherein the force output member comprises a driving portion and a braking portion configured to move relative to the driving portion, wherein the braking portion is configured to rotate in the same direction as the driving portion, and the braking portion is located on a downstream side of the driving portion in a direction of rotation of the force output member;
the first surface is configured to receive the driving force from the driving portion; and
during an engagement of the driving force receiving member and the force output member, the contact surface guides the braking portion to move relative to the driving portion.

9. The driving force receiving member according to claim 8, wherein the convex block further comprises a second surface, and the second surface is configured to receive a braking force from the braking portion.

10. The driving force receiving member according to claim 8, wherein when the driving force receiving member is driven, the braking portion is pressed by the driving force receiving member to retract.

11. The driving force receiving member according to claim 10, wherein the driving force receiving member is further provided with a pressing surface for abutting against the braking portion, and the pressing surface is closer to the connecting portion than a free tail end of the central pillar in the direction of the axis of rotation.

12. The driving force receiving member according to claim 8, wherein the force output member comprises a positioning pillar located in the driving portion, and during the engagement of the driving force receiving member and the force output member, the positioning pillar enters a positioning hole of the central pillar.

13. The driving force receiving member according to claim 2, wherein a flange portion projects radially and outwards from an outer circumference of the central pillar.

14. The driving force receiving member according to claim 2, wherein the driving force receiving member further comprises a projecting portion arranged on the contact surface, wherein when measured along the axis of rotation, a distance from the contact surface to the connecting portion is changed across dimensional scales with a projecting of the projecting portion.

15. The driving force receiving member according to claim 13, wherein in the direction of the axis of rotation, the flange portion is closer to a free tail end of the central pillar than the convex block.

16. The driving force receiving member according to claim 13, wherein in the direction of the axis of rotation, the flange portion is further away from a free tail end of the central pillar than a part of the convex block.

17. The driving force receiving member according to claim 2, wherein in the direction of the axis of rotation, a farthest distance between the first surface and the connecting portion is equal to a farthest distance between the contact surface and the connecting portion.

18. A rotating assembly, comprising:
a rotating member, and
the driving force receiving member according to claim 1.

19. A process cartridge, comprising:
a process cartridge casing, and
the rotating assembly according to claim 18, wherein the rotating assembly is rotatably disposed within the process cartridge casing.

20. The process cartridge according to claim 19, wherein the rotating member is a photosensitive drum, and the process cartridge further comprises a charging member in contact with the photosensitive drum, and a friction member arranged adjacent to and in contact with the charging member.
